(19) United States
(12) Patent Application Publication
(10) Pub. No.: US 2005/0060216 A1
(43) Pub. Date: Mar. 17, 2005

(54) System and method for supporting design change, and recording medium having the method stored

(76) Inventors: Toshiyuki Sakuma, Kawasaki (JP); Yuzo Hiroshige, Tokyo (JP); Yoshiharu Sekiya, Yokohama (JP); Noriyuki Haga, Yokohama (JP); Takashi Tsuno, Yokohama (JP); Katsushi Yokohama, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/929,440

(22) Filed: Aug. 31, 2004

(30) Foreign Application Priority Data
Sep. 16, 2003 (JP) 2003-322429

(51) Int. Cl. G06F 17/60

(52) U.S. Cl. 705/8

(57) ABSTRACT

A design change support system constructed to store profile data containing information of products and members, alternative relevant data containing the relation between a old member and a new member and data of the inventory, consumption and delivery of each member, to read out a delivery lead time of each member contained in the profile data, to, when a product test due date is entered, order necessary members and calculate a consumption schedule of alternative members on the basis of the product test due date, and to contrive one or more schemes of the test configuration containing the member constitution of a product capable of being tested on a day near the product test due date and the test start date by using the delivery and stock status data and alternative relevant data of each member.

### BACKGROUND OF THE INVENTION

The present invention generally relates to the technology for supporting design change of a product that is composed of a plurality of parts or materials, and particularly to techniques for supporting the design change caused by the change of parts or materials that constitute the product. In the present invention, the design change comprises engineering change.

A patent document 1, JP-A-2003-242326, discloses a support system for countermeasure against sudden event that is intended to quickly restore the temporal demand-and-supply unbalance caused by sudden change of warehousing condition or order entry. In this prior art, an MPS based on change information is prepared for each of a plurality of urgencies, MRP computation is made for each MPS to produce the parts-shipping and-receiving results, and the results are compared to judge the content and urgency of the problem. Also, in this prior art, the shipping and receiving simulation is made to confirm the remedy effect of the temporary measure, and so that an actual countermeasure can be contrived. If the design must be changed, a part list is temporarily edited on the input unit of PDM or the like to produce an idea of design change, and the design change information is sent to a SCM system so that the MPR computation with the change applied is made. The output results are fed back to the input unit so that the effect of design change can be confirmed in advance.

In the floor of production, design change frequently occurs due to the change of parts or materials (hereinafter, called the members). When a design change occurs, it is necessary to test all the members to be changed and the product manufactured by using the members before the product after design change is started to produce.

Inventions have so far been proposed to support the design change caused by the change of the members as described about the prior art. However, in recent years, as the international environmental control advances, the design change opportunities and the number of the members to be required to change have been increased markedly. For example, in EU (European Union), products containing particular chemicals will be prohibited not to sell from June 2006 under a directive of ROHS. Therefore, the manufacturing corporations in EU and those to produce the products to EU have actively developed a tendency to make design change toward the members not containing the particular chemicals. The increase of the design change opportunities and the number of the members to be required to change increases the workload on various operations of the actual design development process. Particularly, this increase of the workload noticeably appears in the operation for testing products and in the operations before and after this product-testing process. In addition, the excess or deficiency problem with the stock of the members also eminently appears in those operations at the same time.

Moreover, the members corresponding to the change due to design change are high likely to be delayed in their delivery date. Thus, the designer copes with the delay out of delivery date by issuing an order to search for the old members previously used before design change in addition to the order for new members. As a result, the increase of the workload and the excess or deficiency problem with the stock are further amplified.

### SUMMARY OF THE INVENTION

Under this circumstance, a support system has been demanded to develop that can support to reduce the load due to the design change of the members on the design development process, solve the excess or deficiency problem with the stock of both new and old members, and decide the timing of switching the new and old members and a product test process.

A design change support system according to the invention has an input unit, an output unit, a memory unit and a processing unit. The memory unit has stored therein profile data containing information of products and members, alternative relevant data containing the relation between an old member of the members before design change and a new member of the members after design change, and data of the current status and schedule of inventory, consumption and delivery of each member. The processing unit makes processes for reading out at least a delivery lead time from a procurement base about each member contained in the profile data; when a product test due date is supplied from the input unit, ordering members necessary for the product test and calculating the consumption schedule of alternative members by referring to the alternative relevant data on the basis of the inputted product test due date; contriving one or more schemes of test configuration containing the member constitution and test start date of a product capable of being tested on a day near the product test due date by using the delivery and stock status data and alternative relevant data of each member stored in the memory unit and supplying them to the output unit; accepting the result of the test configuration selection from the input unit, and evaluating the effectiveness of the member changeover about the member constitution of a product judged to be capable of design change by using the data of the inventory and consumption of each member held in the memory unit on the basis of the result of product test selection supplied from the input unit; contriving one or more schemes of member changeover due date, and supplying them to the output unit; and accepting the result of selecting a scheme of member changeover due date, evaluating the effectiveness of the member changeover on the selected scheme of member changeover due date by using the data of the delivery and stock status of each member stored in the memory unit, and supplying the evaluation result to the output unit.

Also, in the design change support system according to the invention, a program is executed to start processes with a predetermined cycle and to achieve various functions from the memory unit, and various data is read and written in the processing unit so that one or more computations are performed.

According to the invention, product test operations and member procurement operations can be made effective, and systematizing that method can reduce the workload. In addition, it is possible to solve the excess or deficiency problem with the inventories of both new member and old member and to support the determination of product test time and member changeover time.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram to which reference is made in explaining a logistics/information distribution network model in one embodiment of the invention.

FIG. 2 is a diagram useful for explaining the construction of a system of the embodiment according to the invention.

FIG. 3 is a diagram showing the hardware structure of the embodiment according to the invention.

FIG. 4 is a diagram showing the functions of the system according to the embodiment of the invention.

FIG. 5 is a diagram showing the flow of the design change process.

FIGS. 6A and 6B are diagrams showing the item tree structure according to the embodiment of the invention.

FIGS. 7A and 7B are diagrams showing an alternative item tree structure according to the embodiment of the invention.

FIGS. 8A, 8B and 8C are diagrams showing the stock capacity and alarm capacity according to the embodiment of the invention.

FIGS. 9A and 9B are diagrams showing the table structures of inventory experience data and consumption schedule data.

FIG. 10 is a diagram showing a processing step 501.

FIG. 11 is a diagram showing the processing step 501.

FIG. 12 is a diagram showing the processing step 501.

FIG. 13 is a diagram showing the processing step 501.

FIG. 14 is a diagram showing the processing step 501.

FIG. 15 is a diagram showing a processing step 502.

FIG. 16 is a diagram showing the processing step 502.

FIG. 17 is a diagram showing the processing step 502.

FIG. 18 is a diagram showing the processing step 502.

FIG. 19 is a diagram showing a processing step 503.

FIG. 20 is a diagram showing the processing step 503.

FIG. 21 is a diagram showing a processing step 504.

FIG. 22 is a diagram showing the processing step 504.

FIG. 23 is a diagram showing the processing step 504.

FIG. 24 is a diagram showing a processing step 505.

FIG. 25 is a diagram showing the processing step 505.

FIG. 26 is a diagram showing a processing step 507.

FIG. 27 is a diagram showing the processing step 507.

FIG. 28 is a diagram showing the processing step 507.

FIG. 29 is a diagram showing a processing step 508.

FIG. 30 is a diagram showing the processing step 508.

### DETAILED DESCRIPTION OF THE INVENTION

An embodiment of the invention will be described below.

(1) Logistics/Information Distribution Network Model to which this Invention is Assumed to Apply

First, description is made of the logistics/information distribution network model to which this embodiment of the invention is assumed to apply.

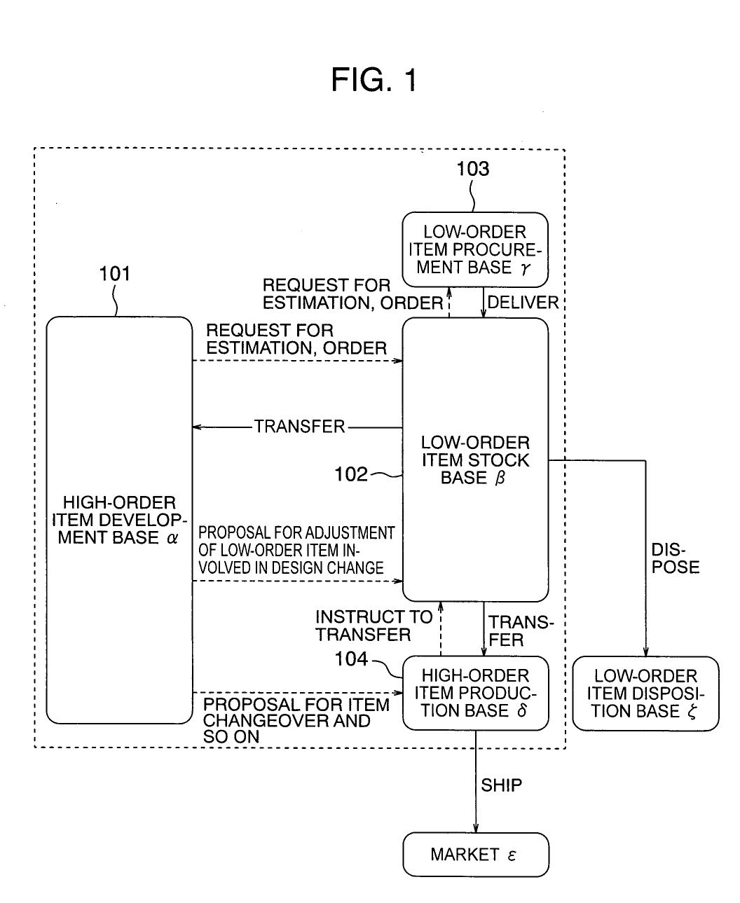

FIG. 1 shows the logistics/information distribution network model to which this embodiment of the invention is assumed to apply.

In this embodiment, the term item is used as the generic name of product, member, half finished product, product in progress, or primary material or as either one of them. Also, for example, a low-order item is used as a member, half finished product, product in progress, or primary material that constitutes a finished product, and a high-order item is used as a member, half finished product, product in progress, or product that is produced by assembling the low-order items. However, in the embodiment mentioned below, the high-order item chiefly indicates a finished product.

The logistics/information distribution network model shown in FIG. 1 has a high-order item development base α 101 that designs and tests high-order items, a low-order item stock base β 102 that receives a request for cost computation of low-order items and an order for the low-order items on the basis of the development contents from the high-order item development base α 101, issues the request and order for low-order items to a low-order item procurement base γ 103, and manages the stock of the low-order items supplied from the low-order item procurement base γ 103, the procurement base γ 103 that supplies the low-order items to the low-order item stock base β 102 in response to the cost computation request and order, and a high-order item production base δ 104 that receives the low-order items transferred from the low-order item stock base β 102, produces a high-order item, and ships it to a market ε.

The flow of items in this model shown in FIG. 1 will be described. There are three flows as given below.

The first flow is the normal flow of supply chain. The low-order item procurement base γ 103 supplies items to the low-order item stock base β 102. The low-order item stock base β 102 transfers the supplied items to the high-order item production base δ 104 under the control of this base δ 104, and the base δ 104 produces a high-order item (finished product) on the basis of the transferred items, and ships it to the market ε where it is sold.

The second flow is the flow for testing high-order items. The low-order item stock base β 102 transfers the items to the high-order development base α 101 under the control of the high-order development base α 101, and the high-order development base α 101 tests high-order items on the basis of the transferred items.

The third flow is the flow of items from the low-order item stock base β 102 to a low-order item disposition base ζ. The low-order item disposition base ζ disposes the low-order items decided to dispose in the low-order item stock base β 102.

The present invention is relevant chiefly to the testing of high-order items in the second flow, and to the inventory control of low-order items by the low-order item stock base β 102 in the first flow.

(2) Construction of a System and Structure of Hardware according to this Embodiment of the Invention

Description will be made of the construction of a system and structure of hardware according to this embodiment of the invention.

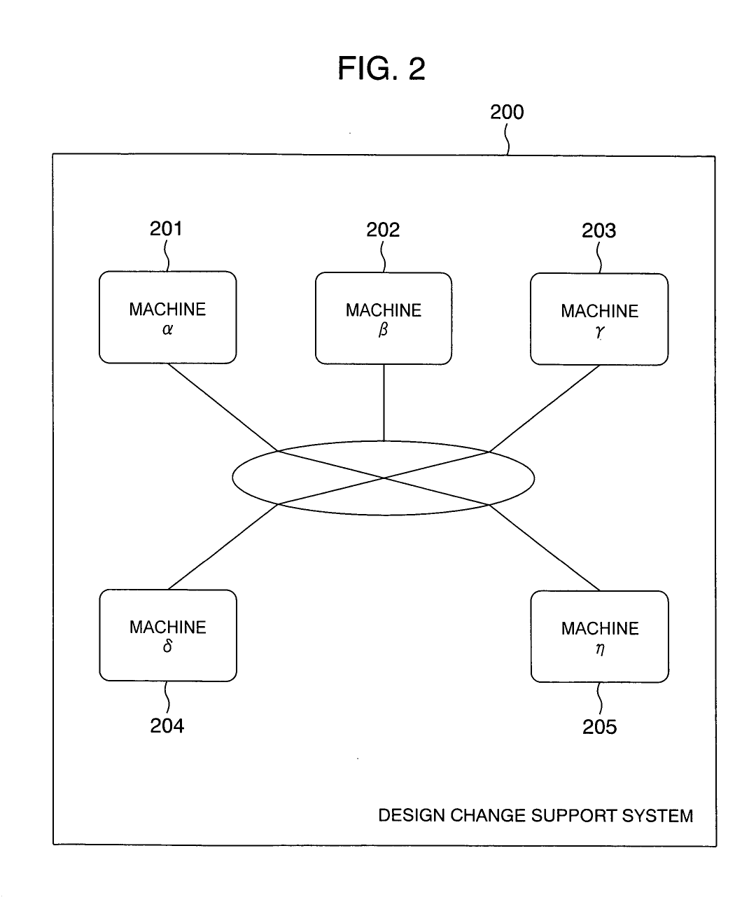

FIG. 2 shows the construction of a system according to this embodiment of the invention.

In this embodiment, a design change support system 200 is formed of a plurality of subsystems interconnected through a network. Each of the plurality of subsystems makes distributed processing on the various different functions, which will be described below.

A machine α 201 of the subsystems of the design change support system 200 is an information processing machine provided within the high-order item development base α 101. This machine α 201 manages the progress information of design change operations. A machine β 202 is an information processing machine provided within the low-order item stock base β 102. This machine β 202 manages information of estimation request history, order history and stock status. A machine γ 203 is an information processing machine provided within the low-order item procurement base γ 103. This machine manages information of estimation answer history and delivery schedule. A machine δ 204 is an information processing machine provided within the high-order item production base δ 104. This machine manages information of item consumption schedule. A machine η is an information-processing machine that consolidates and manages the other machines.

The design change support system according to the invention is not limited to the construction for making distributed processing, but may take a construction for making integrated processing by a single machine. In addition, parts of respective machine functions may be recombined, divided into smaller portions or integrated. Moreover, while the design change support system in this embodiment is built as an independent system, the invention is not limited to that construction. The system of this invention may be incorporated in another information processing system to operate as a part of the latter system.

(3) Hardware Structure of the Design Change Support System According to the Embodiment of the Invention

Description will be made of the hardware structure of the design change support system according to the embodiment of the invention.

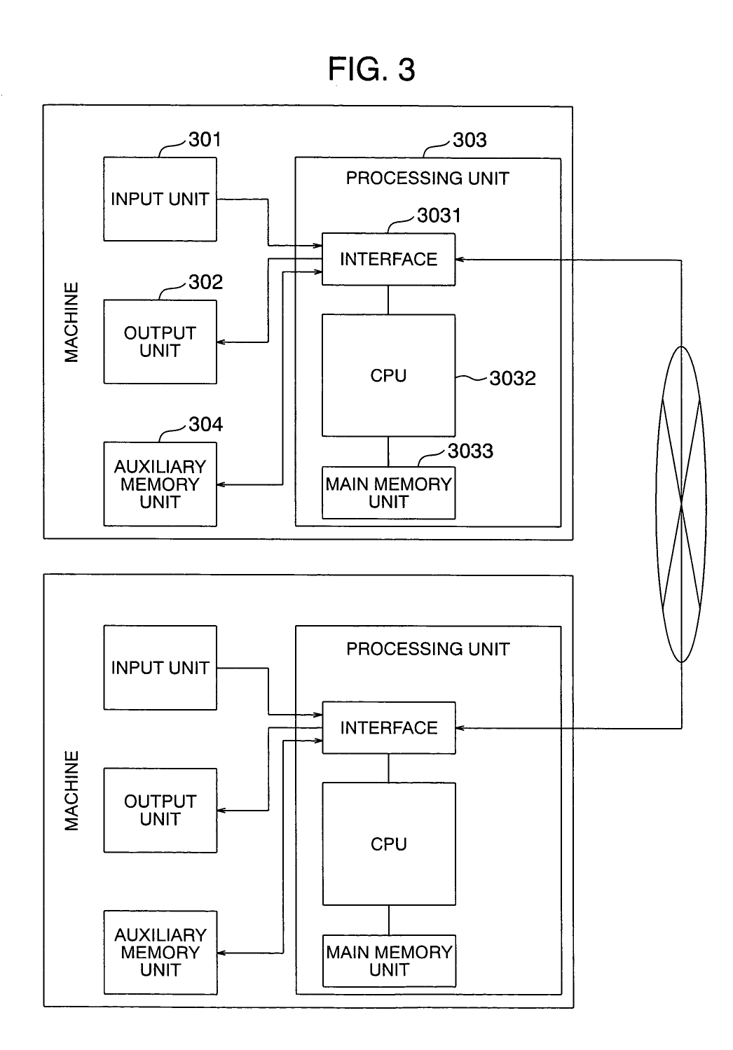

FIG. 3 shows the hardware structure of the system of this embodiment of the invention.

As shown in FIG. 2, the design change support system 200 of this embodiment has a plurality of information processing machines interconnected through a network.

Each information-processing machine has an input unit 301 such as a keyboard or mouse, an output unit 302 such as a display, an auxiliary memory unit 304 and a processing unit 303 for executing a design change support program. The processing unit 303 includes an interface 3031, a central processing unit (hereinafter, referred to as CPU) 3032, and a main memory unit 3033. The processing unit 303 is connected to the input unit 301, output unit 302 and auxiliary memory unit 304 through the interface 3031.

In this embodiment, the results of executing the design change support program are stored in a region acquired within the main memory unit 3033. The program is previously held in the auxiliary memory unit 304, and it is then read from the unit 304 and written in the main memory unit 3033. The CPU 3032 executes this program to achieve various different functions.

Also, while the design change support system in this embodiment is materialized by the multipurpose information processing machines and software, it may be realized by, for example, a combination of hardware including a hard-wired logic and a multipurpose information-processing machine having a program incorporated in advance.

(4) Functions of the Design Change Support System and the Codes and Data Used in the System

Next, the functions of the design change support system will be described.

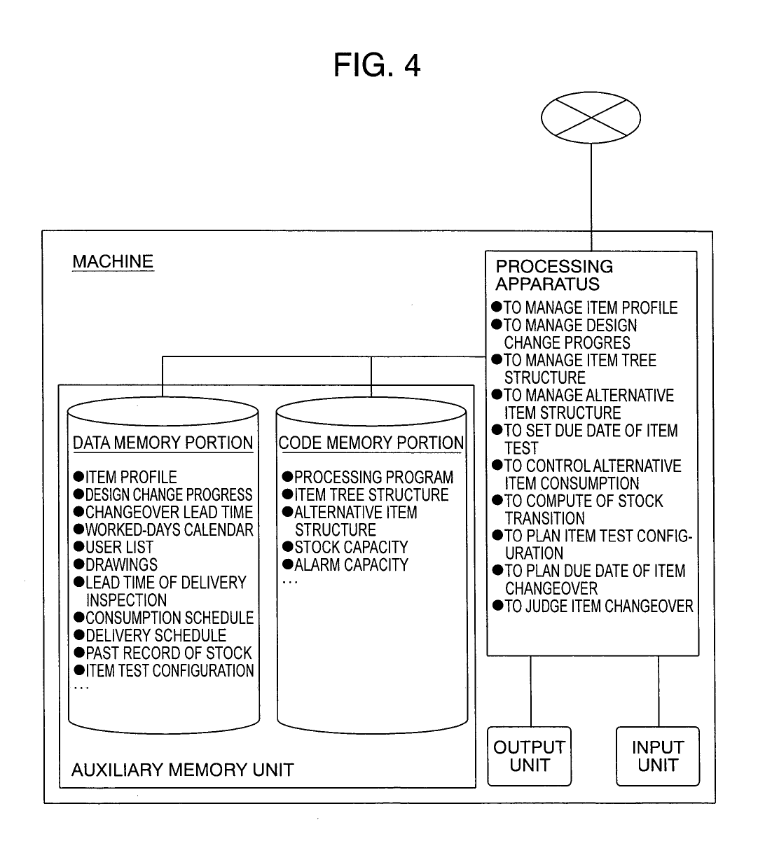

FIG. 4 shows the functions owned by the design change support system 200 according to the embodiment of the invention.

In FIG. 4, an example is shown in which one information-processing machine has all functions of design change support system 200 and the data and codes used in the system. The construction shown in FIG. 4 is used in a case where the machine η 205 that makes integrated management of the other information processing machines shown in FIG. 2 stores all programs, data and codes so as to make concentrated processing, or in another case where the information processing machine provided at each base makes access to this integration management machine η 205 through the network as the need arises, and reads out a necessary program and necessary data to make distributed processing.

In addition, the information-processing machine of each base may have all the functions, data and codes provided or may have only necessary functions provided.

As shown in FIG. 4, in the design change support system 200, the processing unit 303 executes a program on the basis of various pieces of information stored in the auxiliary memory unit 304, achieving functions of item profile managing function, design change progress managing function, item tree structure managing function, alternative item structure managing function, item test due date setting function, alternative item consumption controlling function, stock transition computing function, item test configuration planning function, item changeover due date planning function, and item changeover judging function. The details of process contents to achieve each of these functions will be described in turn in conjunction with the processing flow.

In this embodiment, the auxiliary memory unit 304 has provided therein a code memory portion and a data memory portion. The code memory portion holds basic data that is low in the frequency of content change, such as processing programs to materialize each function, item tree structure code, alternative item structure code, stock capacity code, and alarm capacity code. The data memory portion holds data that is relatively high in the frequency of being rewritten at the time of each kind of processing and data input, such as item profile data, design progress data, changeover lead time data, worked-days calendar data, user list data, drawing data, delivery inspection lead time data, consumption schedule data, delivery schedule data, stock experience data, and item test configuration data.

Here, supplementary explanation will be made of some of the codes and data stored in the code memory portion and data memory portion of the auxiliary memory unit 304.

(4. 1) Item Tree Structure Code

First, item tree structure code and alternative item structure code will be described.

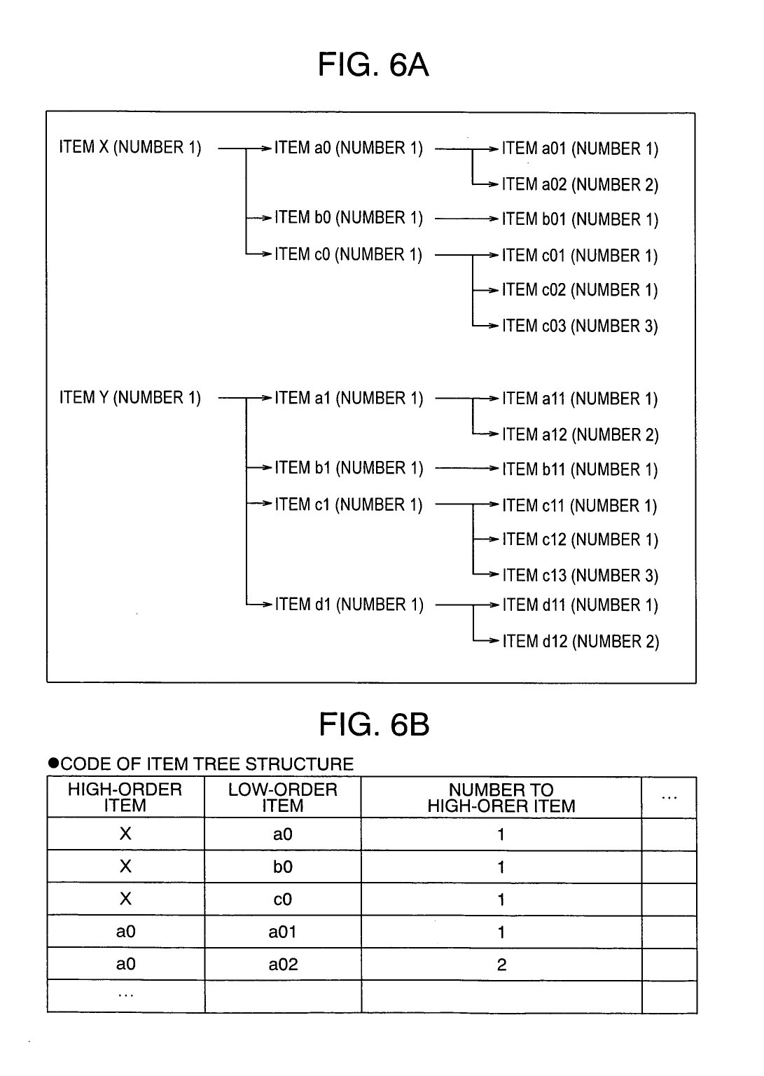

FIGS. 6A and 6B are, respectively, an image diagram of the item tree structure and a diagram showing stored data of the structure in this embodiment. An item X and item Y are highest-order items (finished products). The other items of item a0 and so on are items (members) that constitute a highest-order item. The item tree structure data is stored to have high-order items, low-order items and number of low-order items to each high-order item.

(4. 2) Alternative Item Structure Code

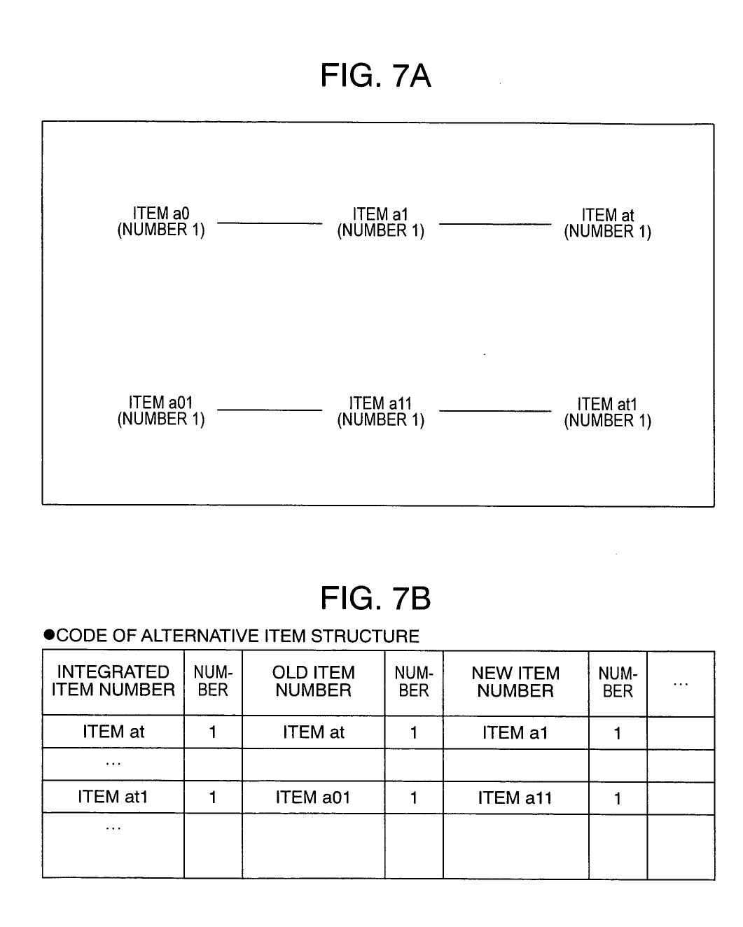

FIGS. 7A and 7B are, respectively, an image diagram of alternative item structure and a diagram showing the stored data of the item structure in this embodiment. In FIGS. 7A and 7B, item a0 and item a1 have an alternative relation to each other. An item at is a common name to the items a0 and a1. Also, an item a01 and an item a11 also have an alternative relation. An item at1 is a common name to the items a01 and all. The common names at, at1 are used when the items having an alternative relation are managed together for their stock.

The stock capacity code and alarm capacity code will be described next.

(4. 3) Stock Capacity Code and Alarm Capacity Code

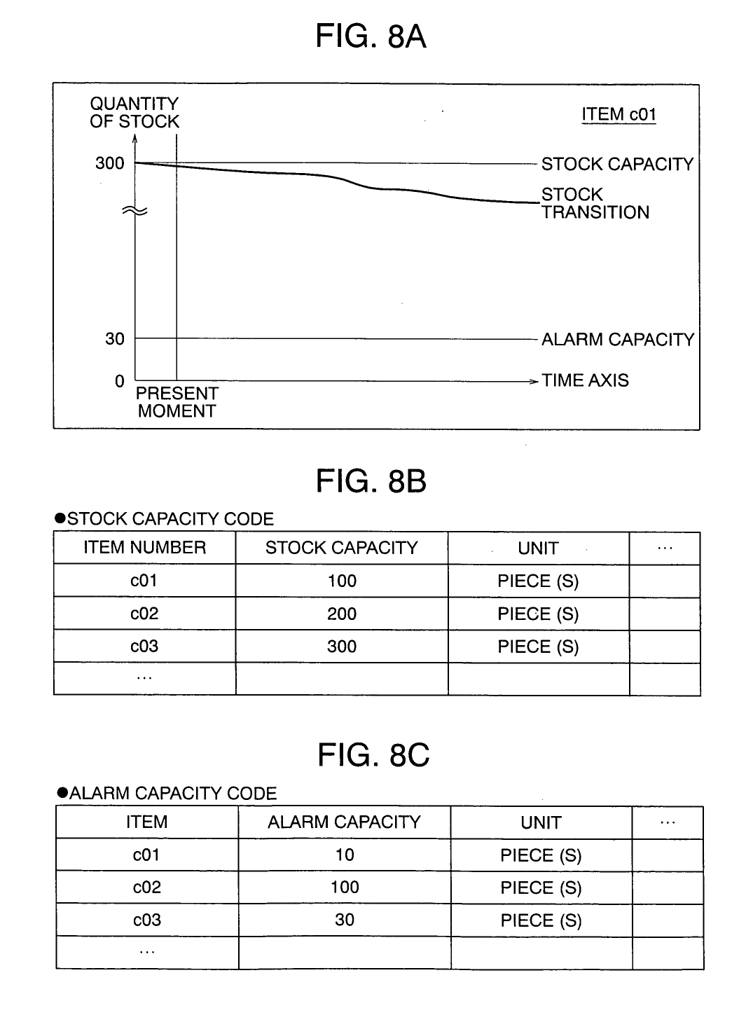

FIGS. 8A, 8B and 8C show the stock capacity code and alarm capacity code in this embodiment. The alarm capacity stands for the lower limit of stock at which an alarm is given. This capacity is set for each item. The stock capacity stands for the upper limit of stock over which the stock cannot be replenished. In an example shown in FIGS. 8A˜8C, the stock capacity of item c01 is 100, that of item c02 is 200, and that of item c03 is 300. The alarm capacities of item c01, item c02 and item c03 are 10, 100 and 30, respectively.

(4. 4) Stock Experience Data

Description will be made of the table structure of the stock experience, or past-record data stored in the auxiliary memory unit 304.

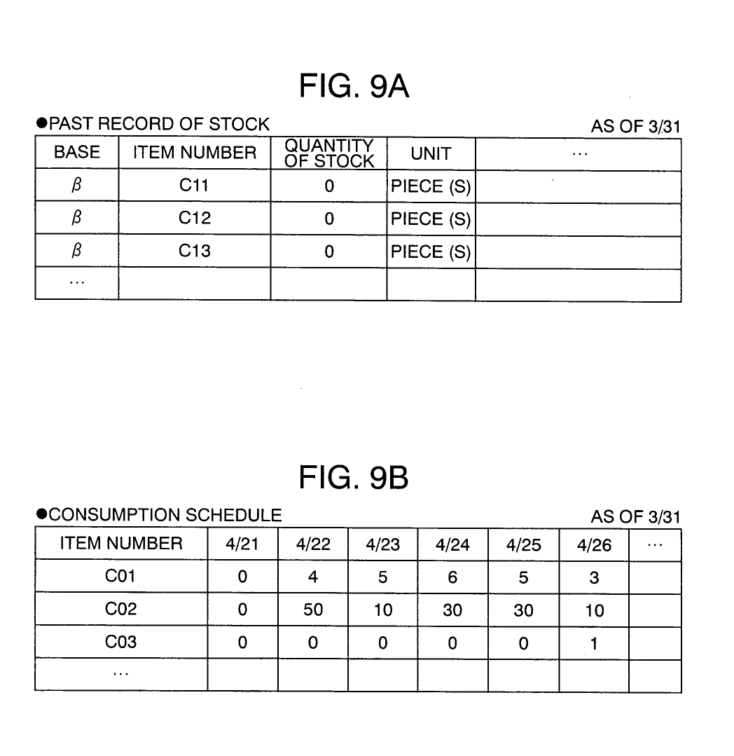

FIG. 9A is a table of the table structure of the stock experience data showing the stock status in this embodiment. The table has a base column, an item number column, a stock quantity column, and a unit column. The base column holds the name of the base that manages the stock. In the base column, “α” is written for development base α 101, β for inventory base β 102, “γ” for procurement base γ 103, and “δ” for production base δ 104. The item number column holds the number of item. The stock quantity column holds the stocked quantity of item. The unit column holds the unit for use in counting the number of item in the stock. For example, the unit of item c11 in inventory base β 102 is “piece(s)”.

(4. 5) Consumption Schedule Data

Next, description will be made of the table structure of consumption schedule data stored in the auxiliary memory unit 304.

FIG. 9B shows the table structure of the consumption schedule data in this embodiment. The table has an item number column, and a consumption schedule column. The item number column holds item number. For example, c01, c02 and c03 are written in the item number column. The consumption schedule column holds planned consumption quantity occurring from now to the future. For example, for item number c01, 0 piece, four pieces, five pieces, . . . are respectively written on April 21, April 22, April 23 . . . .

(5) Design Change Process

The processing sequence in the design change support system will be described next.

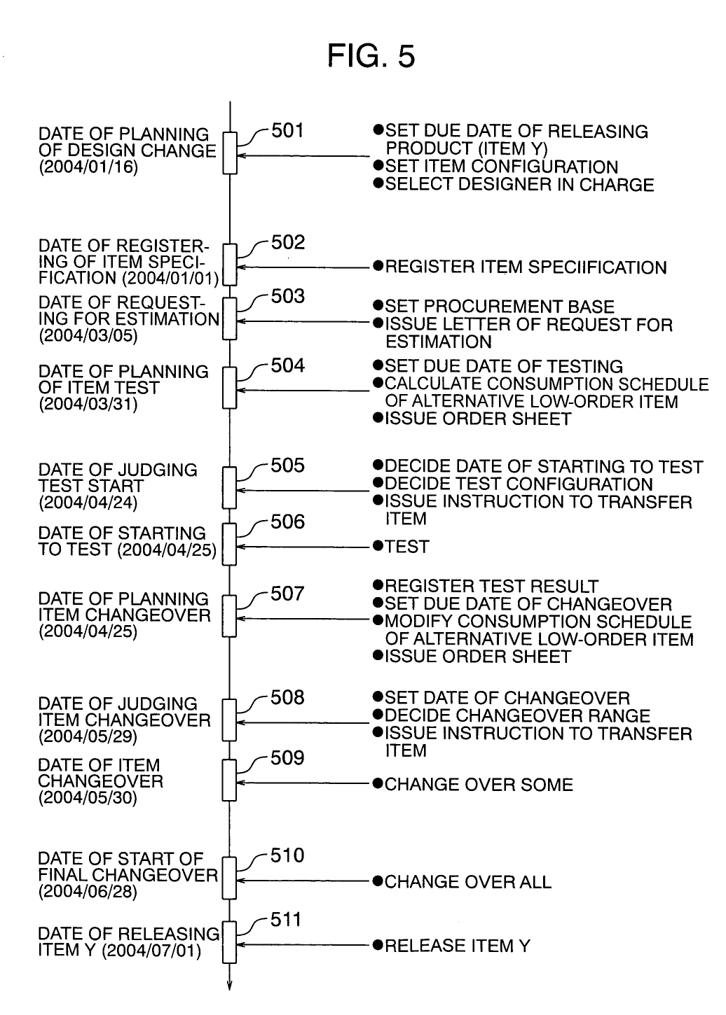

FIG. 5 shows the design change process in which the design change support system of the embodiment according to the invention is used. Here, particularly a single sequence is shown as the design change process without separating the processing bases. This sequence shows the flow of processes for planning the design change on a date (in this embodiment, written as Jan. 16, 2004), registering the specification of item after change (Mar. 1, 2004), estimating necessary members (Mar. 5, 2003), forming a plan for testing (Mar. 31, 2004), starting to work on the test (Apr. 25, 2004), switching members on the basis of the results (May 30, 2004), and releasing the item (Jul. 1, 2004).

The design change in this embodiment is the change of two points, that is, the specification change of a member of a finished product, and the addition of a new member. This example will be described.

(5. 1) Design Change-Planning Step

The design change-planning step 501 that is executed on the design change planning date will be described first.

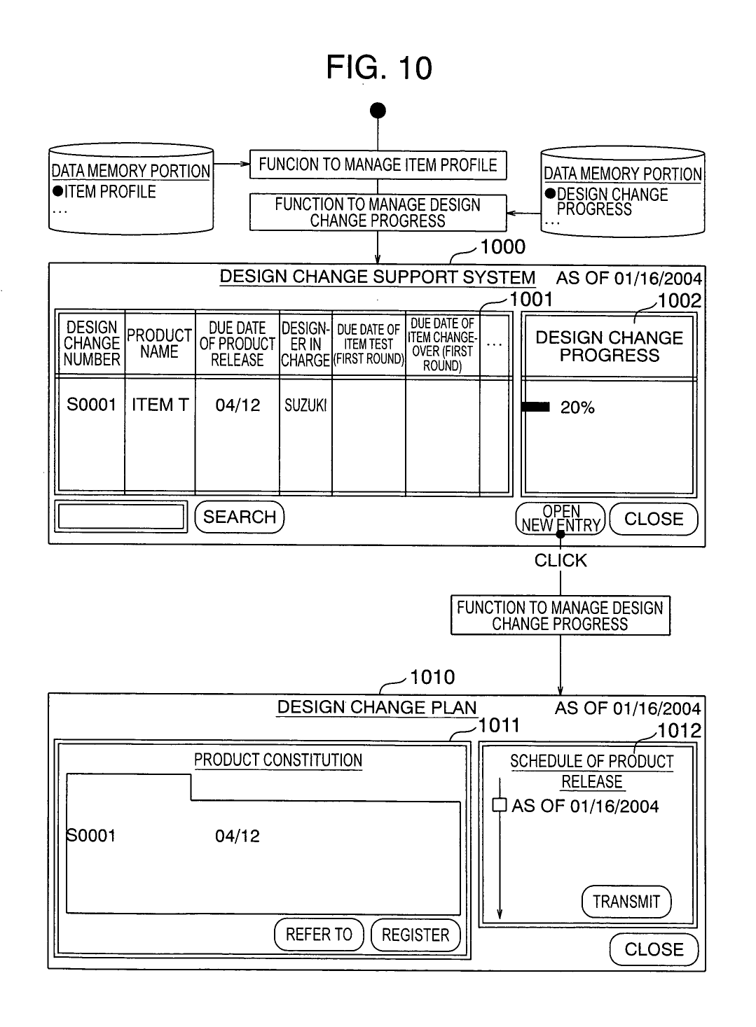

The design change-planning step makes setting of the due date on which a product of item Y is released, setting of item Y structure, and setting of a person in charge who designs item Y. In this embodiment, the design change planning date on which those setting operations are made is fixed on Jan. 16, 2004. The processing contents of this step 501 will be described with reference to FIGS. 10 through 14. FIGS. 10 through 14 show output images, functions to be started, while the output images are displayed one after another, to produce those output images, and data read out when the functions are started, or show the processing contents of step 501.

The item profile managing function is first started, reading out an item profile from the data memory portion, and then, the design change progress managing function is started, reading out design change progress data from the data memory portion, those data being displayed on the display screen. The item profile, as shown in FIG. 10 at 1001, is data of design change number renewed at each design change, name of product changed in its design, due date on which that product is released, person in charge who designed, and due date on which the item test is performed. The content of the design change progress data, though not shown here, is the information about the design change scheme found out at each design change number (the names of the low-order items constituting the product, the person in charge, and progress information of each low-order item). The design change progress is totally computed on the basis of that information by a predetermined computation method, and expressed in percent figures as shown in FIG. 10 at 1002.

Next, when the “OPEN NEW ENTRY” button in image 1000 is clicked, the design change progress managing function is actuated to make an image displayed for registering a new design change scheme (as shown at 1010). The registration image 1010 includes a region 1011 for displaying the product structure corresponding to the new design change scheme (since the product structure is not yet registered, this region is blank), and a region 1012 for registering a due date on which a product is released. The present date is displayed in this region 1012.

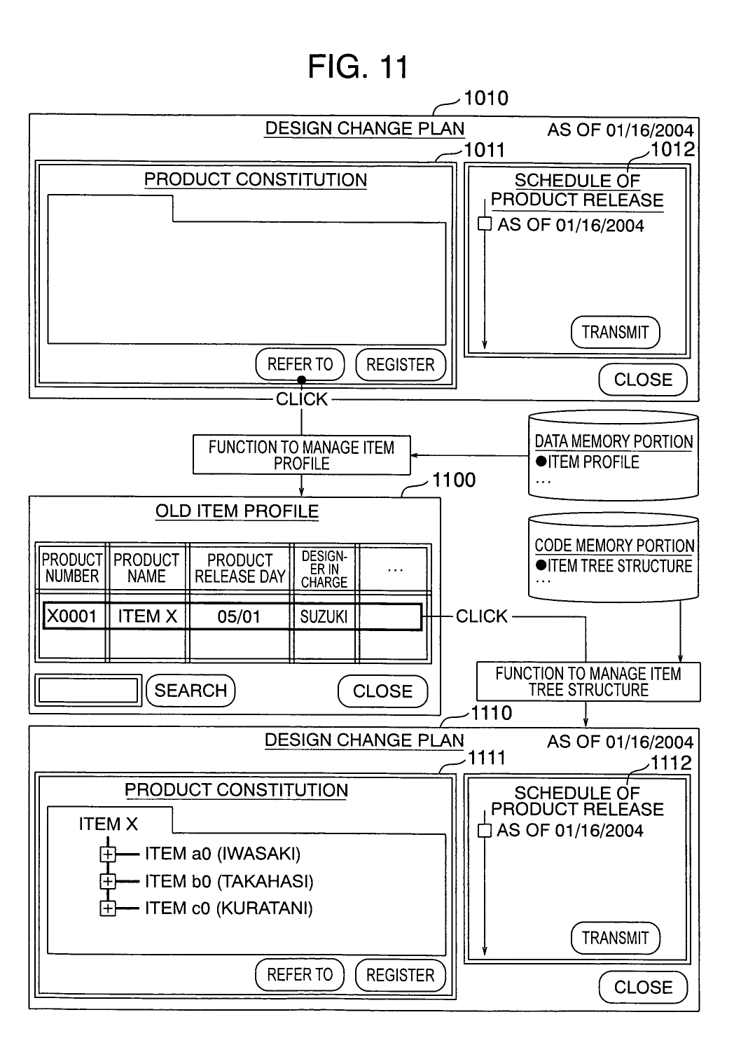

The following processing content will be described with reference to FIG. 11. The image 1010 shown in FIG. 11 is the same as that shown in FIG. 10. When the “REFER TO” button in region 1011 is clicked, the item profile managing function is started to refer to the item profiles stored in the data memory portion and to make the profiles of the items already registered be displayed (1100). When a certain item (here, item X) is selected from the displayed items, the item tree structure managing function is started to refer to the item tree structures stored in the code memory portion and to make the tree structure of item X be displayed (1111). The item tree structure code of each item stored in the code memory portion holds names of low-order items of the item and persons in charge who designed the low-order items. That information is displayed on the screen.

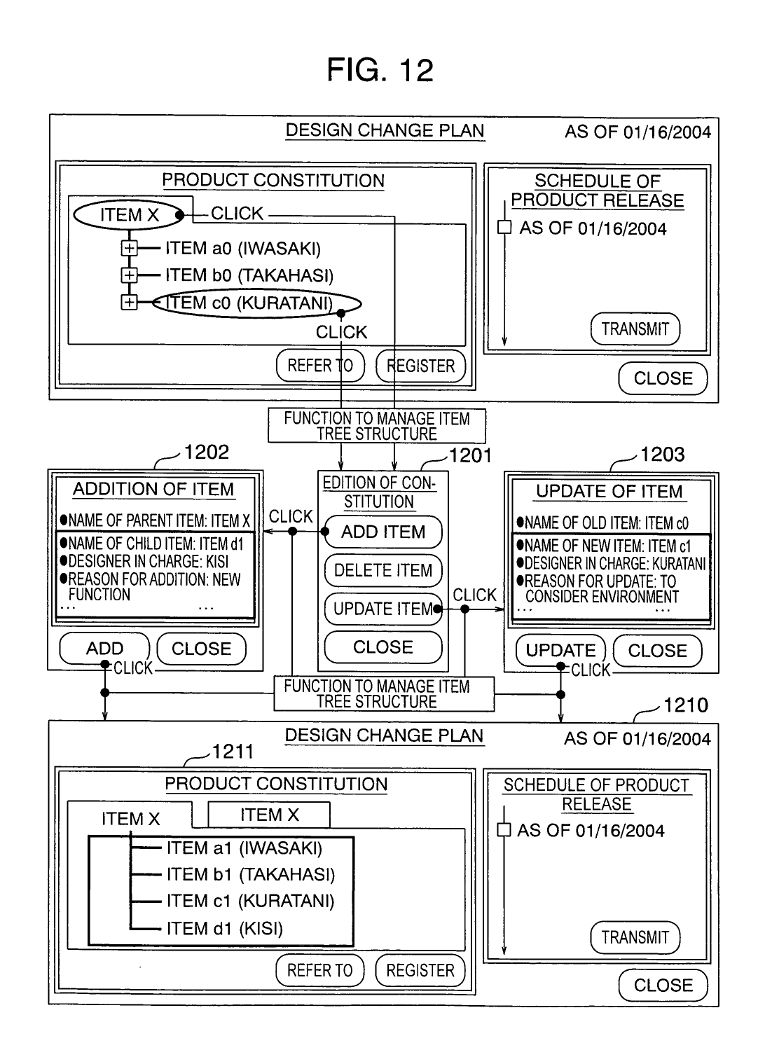

The processing status goes to FIG. 12. Since this design change is the addition of a new item and the change of an item, the operator first clicks the item X as a high-order item to be added. Then, the item tree structure managing function is actuated to make a structure-editing region 1201 be displayed. Here, when the “ADD ITEM” button in the structure-editing region is clicked, an item addition-registering region is displayed. Here, when the operator enters the names of child items to be added, persons in charge who designed the items, and reason for addition, and then clicks the “ADD” button, the item tree structure managing function is started to make the product structure be displayed that shows the structure after the addition of low-order items. Further, the item c0 to be renewed is clicked. Then, similarly, the item tree structure managing function is started to make the structure-editing region 1201 be displayed. Here, when the “UPDATE ITEM” button is clicked, an item-updating region is displayed. When the operator enters update content and then clicks the “UPDATE” button, the item tree structure managing function is started to make the product structure be displayed that shows the structure after the update of the low-order item. The member structure updated after the addition of low-order item is shown in FIG. 12 at 1210. The image shown in FIG. 12 at 1210 shows the structure updated after the previous addition of the items d1 and c1 and also after the addition of items a1 and b1.

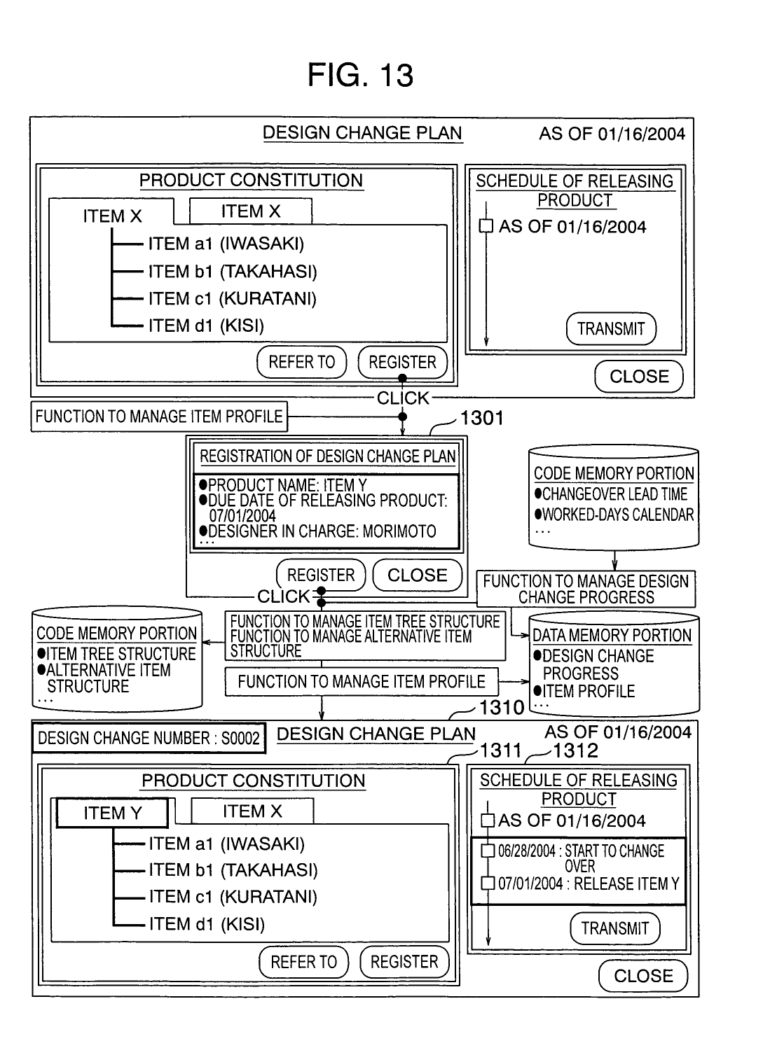

The processing status goes to FIG. 13. The operator registers the low-order items of item X added and changed as above. When the “REGISTER” button is clicked, the design change plan-registering region 1301 is displayed. Here, the operator enters the name of the new product after the design change, the due date on which the product is released, and the persons in charge who designed. Then, when the “REGISTER” button is clicked, the design change progress managing function is started to give a design change number as a new design plan to the design change progress data and register it. Also, this function refers to the item switching lead time and each base's working day calendar stored in the code memory portion and calculates the final changeover start date back from the product-releasing due date. The calculated final changeover start date is held in the design change progress data. In addition, the item tree structure managing function and alternative item structure managing function are started to add items to the item three structure code, and to register the alternative relation in the alternative item structure code. Moreover, the item profile managing function responds to the registered content to update the item profile. Then, the design change number, the item name (item Y) after registration, the final changeover start date, and the item releasing due date are displayed on the screen.

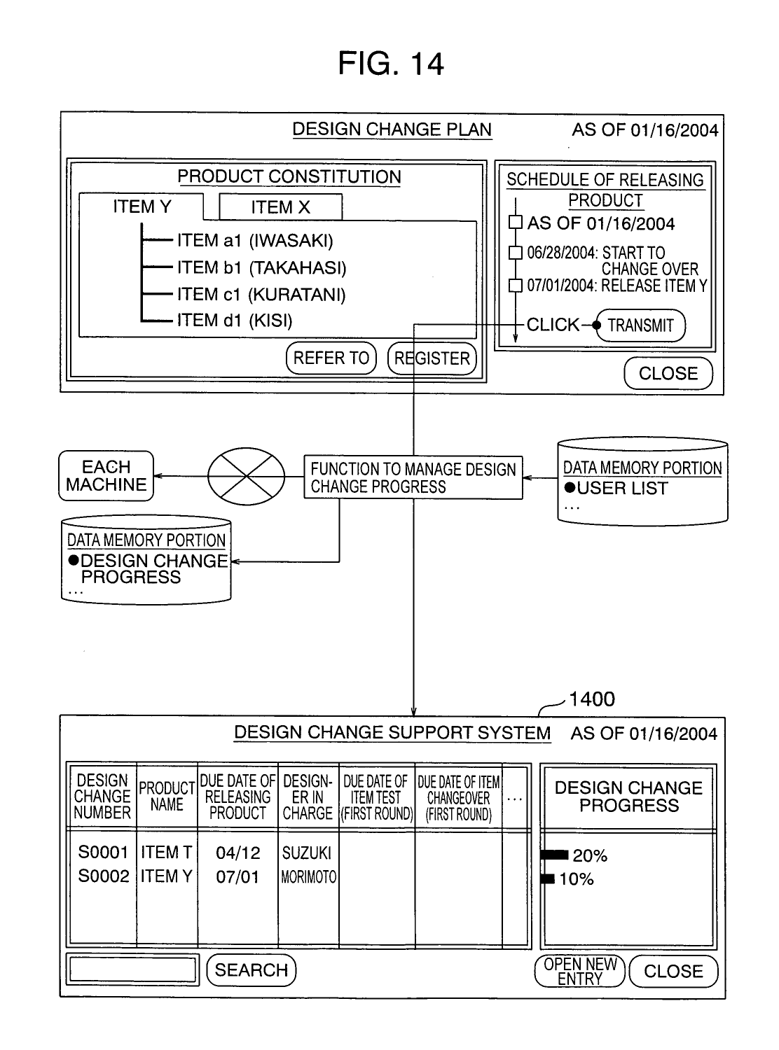

The processing status goes to FIG. 14. When the operator clicks the “TRANSMIT” button in the product releasing due date region 1312, the design change progress managing function is actuated to refer to the user list of the data memory portion and to transmit information of the fixed item-Y product-releasing due date, structure, persons in charge who designed to each related base machine. When the related bases share the fixed information, and review and approve it if necessary, the results are transmitted back. Thus, the design change progress data stored in the data memory portion is updated since the design change plan process is found to have completed from the results, and the progress after the update is expressed in percent figures and displayed on the screen (1400).

(5. 2) Item Specification Registering Step

The process for registering the specifications of the low-order items of item Y will be described next.

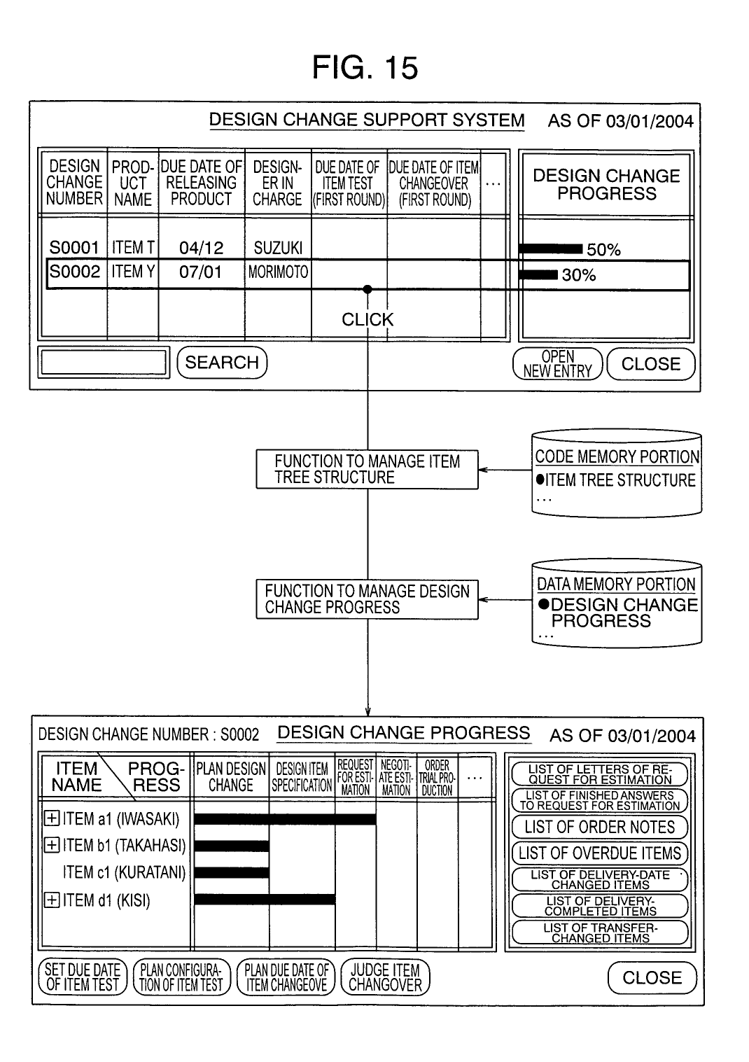

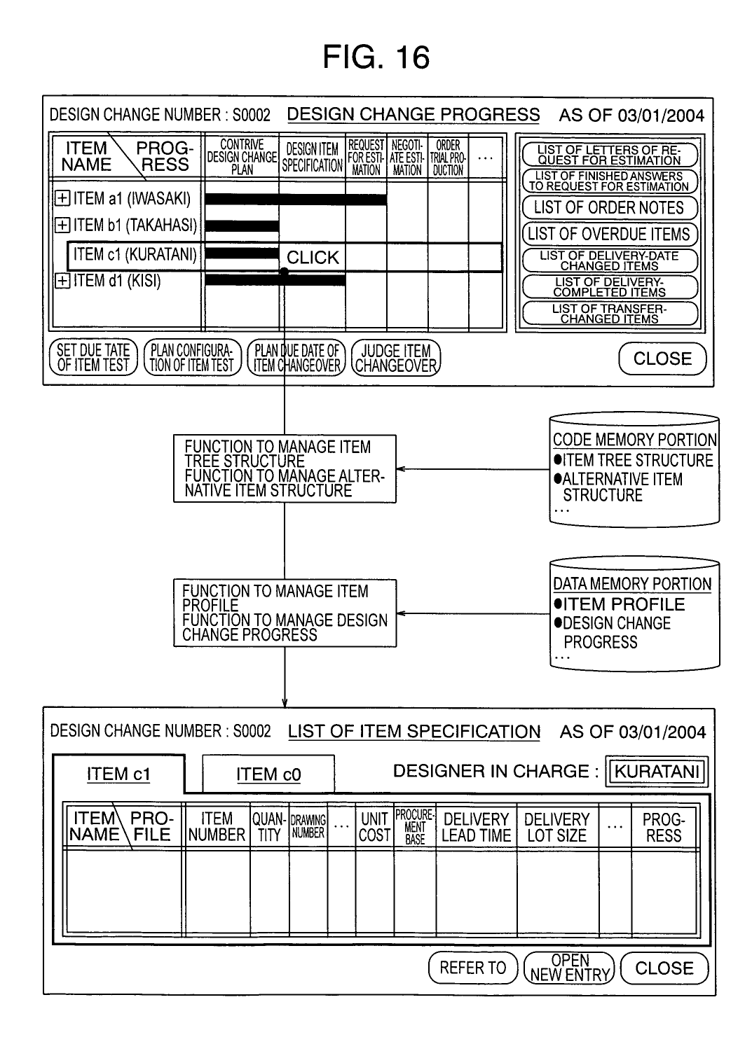

The item specification-registering step 502 is the step for registering the specifications of low-order items of item Y in the machines (FIG. 5, at 502). In this embodiment, this item specification registering date is fixed on Mar. 1, 2004. The processing content of this step 502 will be described with reference to FIGS. 15 through 18. In this step, the base (development base) that has received the results of the processing in step 501 responds to the input of the specifications of items designed by the persons in charge to make the processing.

First, when the operator clicks the number of the design change scheme to which the specification is inputted, the item tree structure managing function is started to refer to the item tree structure code and to unfold the item Y of the selected design change number into components. Then, the design change progress managing function refers to the design change progress data and to display information of the persons in charge and progress status about each low-order item that constitutes the item Y. In this embodiment, the person in charge who enters the specifications at the development base is assumed to be a person (KURATANI) who takes charge of item c1.

First, when this person clicks item c1, the item tree structure managing function and alternative item structure managing function are started. The item tree structure managing function and alternative item structure managing function makes processing while referring to the item tree structure and alternative item structure. Then, the item profile managing function and design change progress managing function are started. The item profile managing function and design change progress managing function make processing while referring to the item profile and design change progress of the data memory portion. Then, the image of item specification list is displayed that includes the item profile data of item c1, profile data of item c0 having an alternative relation with item c1, and progress read out from the design change progress. Each column for the profile data of item c1 is blank since it is not yet registered.

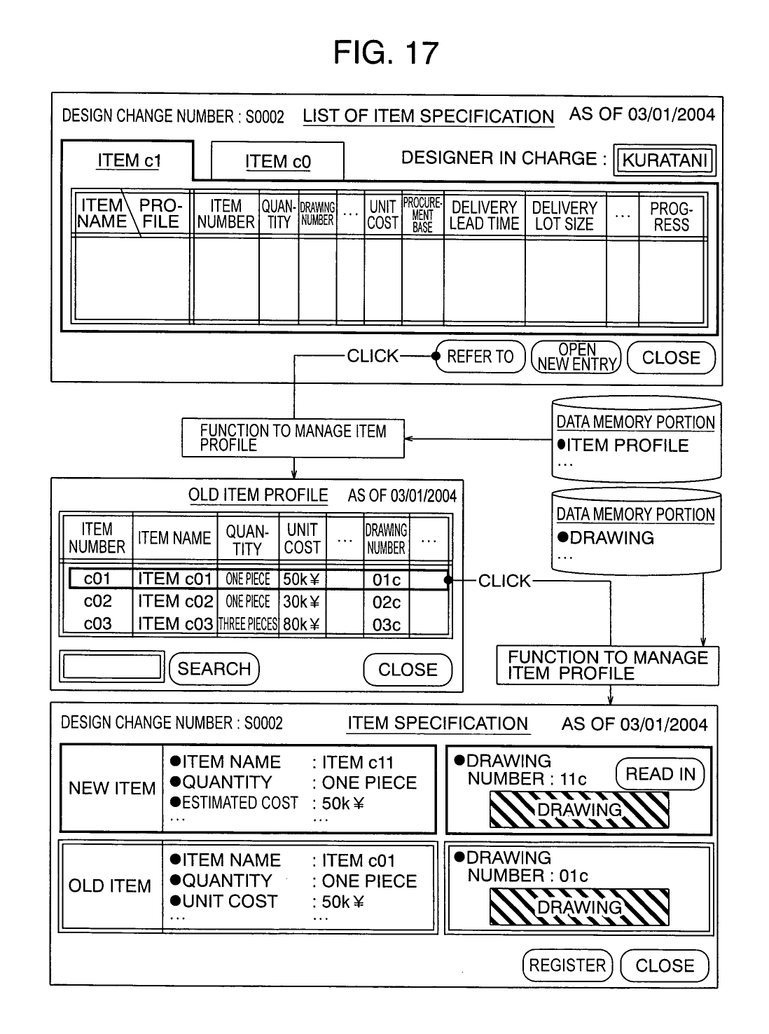

With reference to FIG. 17, the registration processing for the profile data of item c1 will be described. It is here assumed that, when trying to register the profile data of item c1, the operator clicks the “REFER TO” button so that it can be entered while the profile data of item c0 having an alternative relation is being referred to as a prototype. Then, the item profile managing function is started to refer to the item profile of the data memory portion, so that the list of child items of item c0 is displayed in a region 1701 as the old item profile image. If item c01 is selected in region 1701, the item profile managing function is started to refer to the image data of the data memory portion and to display on the screen the selected item c01 as the old item. The copy of the content is displayed on the new column. The displayed profile data of item c11 is modified if necessary while the item profile of item c01 is being referred to as a prototype. In addition, the image of drawing number 11c can be made to associate with item c11 by clicking the “READ-IN” button.

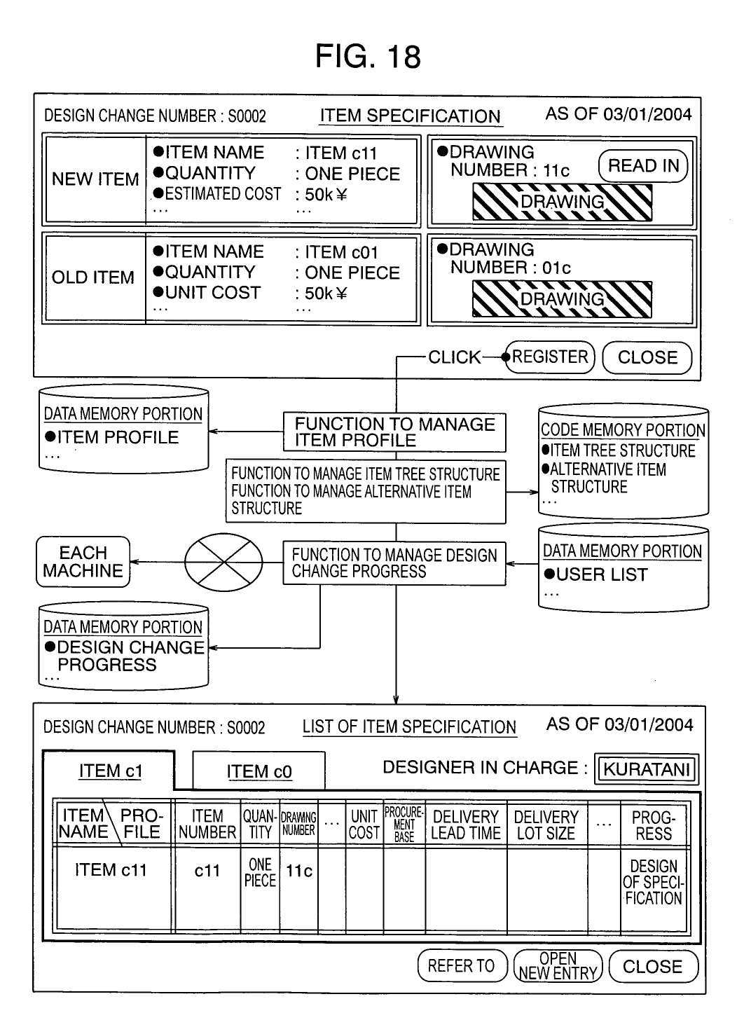

The processing status goes to FIG. 18. When the “REGITER” button is clicked, this content is registered in the item profile by the item profile managing function. The relation with item c11 and item c01 is registered in the item tree structure and alternative item structure by the item tree structure managing function and alternative item structure managing function. The design change progress management function is actuated to refer to the user list of the data memory portion and to transmit the result of this item registering processing to the related base machine. The result is further reviewed and approved if necessary, and the design change progress is updated when the item specification registering process is found to have completed from the result. Then, the progress data after the update is displayed on the screen.

(5. 3) Estimation Letter-of-Request Issuing Step

Next, description will be made of the process for issuing the estimation letter-of-request of the registered item.

In the estimation letter-of-request issuing step 503, the request for estimation is issued to the part that procures the item that the person in charge has inputted on the basis of the registered item specification. In this embodiment, this estimation request date is fixed on Mar. 5, 2004.

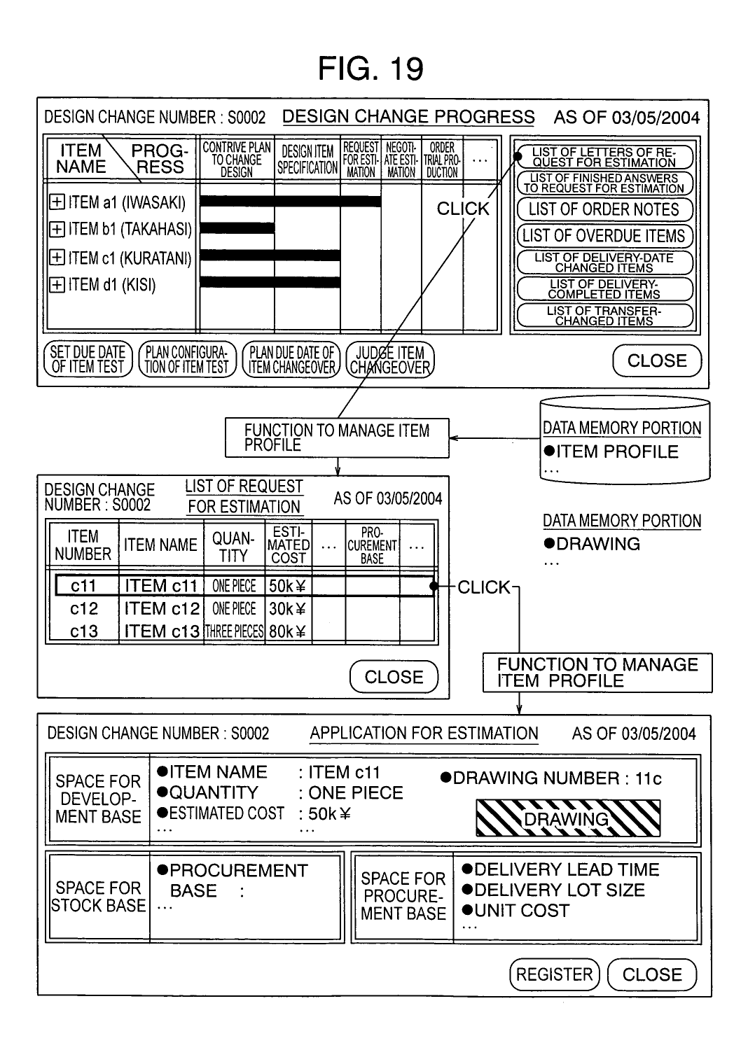

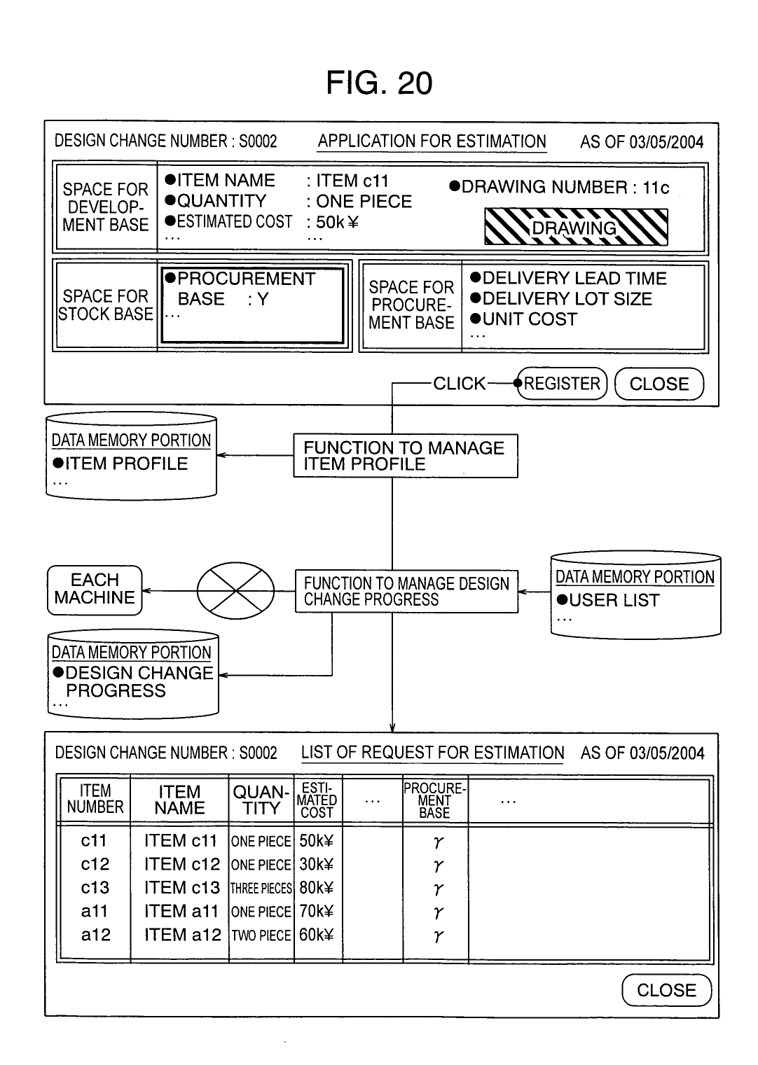

The processing content of this step 503 will be described with reference to FIGS. 19 and 20.

First, the image of design change progress is displayed. The progress of item c1 is at the stage where the specification design has been completed, and the next process is the request for cost computation. Here, when the “LIST OF LETTER-OF-REQUEST FOR ESTIMATION” is clicked, the item profile managing function is actuated to refer to the item profile of the data memory portion and to display the data acquired from the item profile in the image of the list of letter-of-request for estimation. This list has a column of procurement base. In this step, processing is made when a procurement party in this column is selected. When the item c11 is selected in the list, the item profile managing function is actuated to make an image of estimation application be displayed. The processing status goes to FIG. 20. Here, when the operator enters γ as the procurement base, and clicks the “REGISTER” button, the selected procurement base is held in the item profile of item c11. Also, the information of estimation application is transmitted to a related base machine resulting from referring to the user list. After it is reviewed and approved if necessary, the design change progress data is updated since the processing has been completed up to the estimation letter-of-request issuing process.

(5. 4) Item Test Plan Setting Step

The item test plan setting step will be described next.

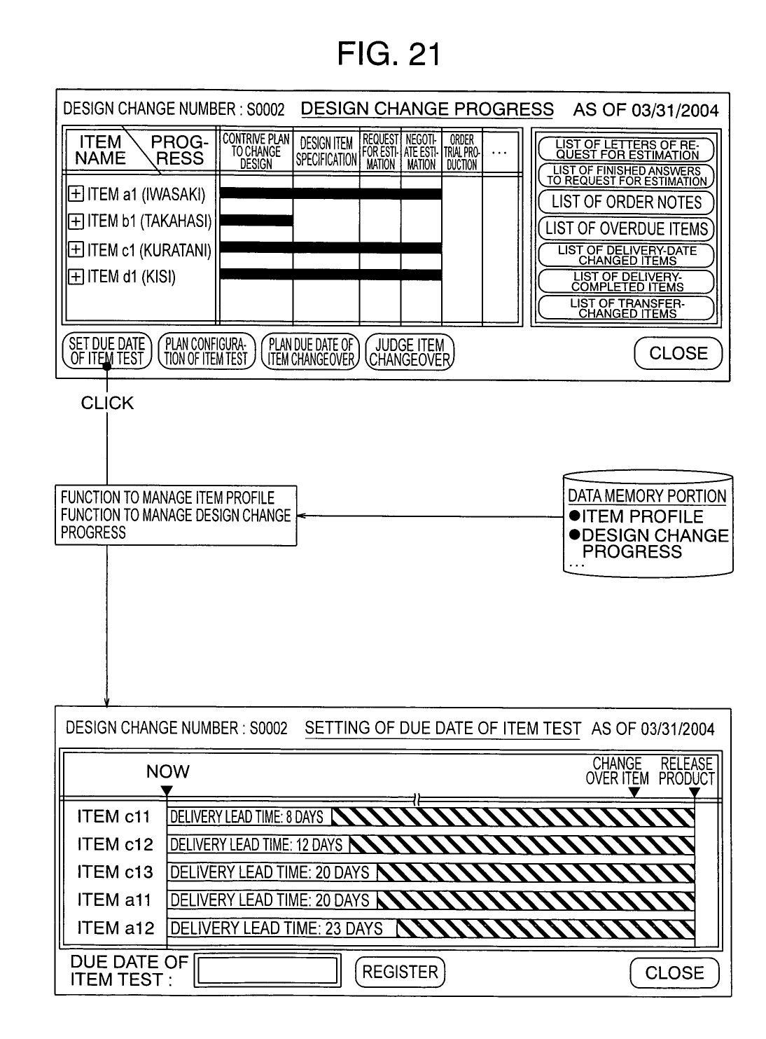

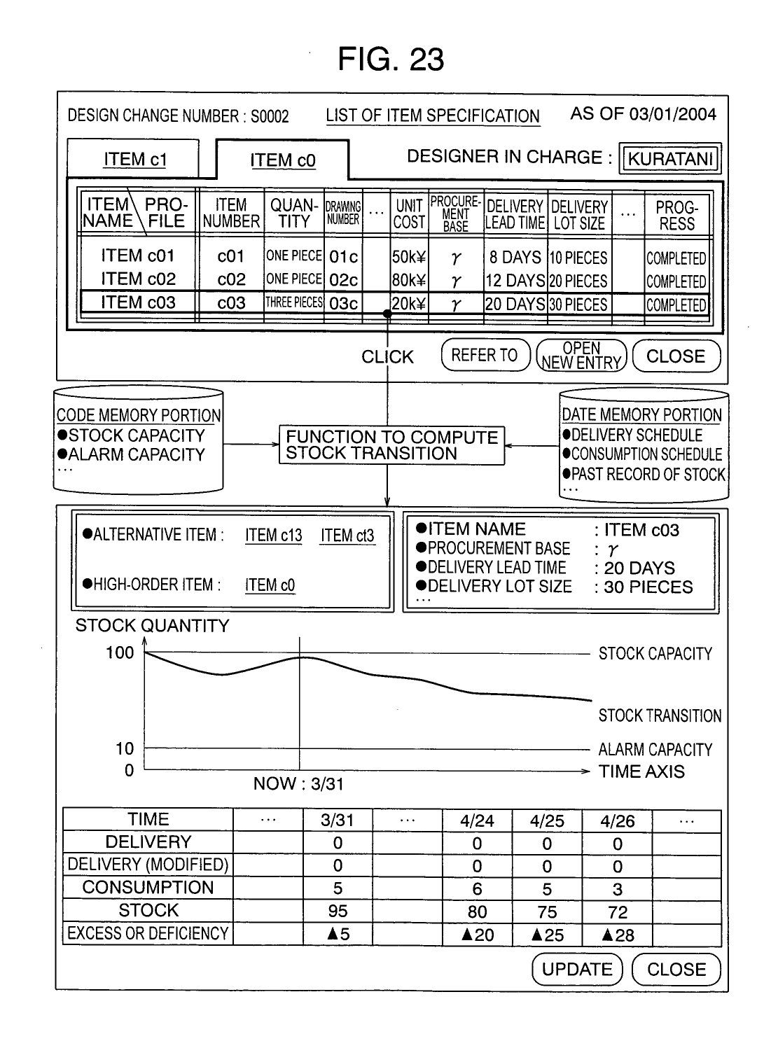

The item test plan setting step 504 fixes the due date of item test, and orders low-order items necessary for test. Also, the step 504, considering that new members such as members necessary for design change generally have a tendency often not to be delivered by the appointed date, registers the current low-order items to be also consumed as alternatives at the same time that the new items are ordered. In this embodiment, this item test planning date is fixed on Mar. 31, 2004. The processing content of this step 504 will be described with reference to FIGS. 21 through 23.

When the request for estimation is issued March 5 in step 503, the answers of delivery lead time, delivery lot size and unit price are sent from the low-order item procurement base that receives this request, and held in the item profile. The image of the design change progress of the corresponding item is first displayed in order to check the contents of these answers and fix the item test plan. When the operator clicks the “SET ITEM TEST DUE DATE” button in this image, the item profile managing function and design change progress managing function are started. These functions operate to refer to the item profile and design change progress data of the data memory portion and to make the image of fixed item test due date be displayed on the screen. This image of fixed item test due date contains a list of the delivery lead-time, item changeover due date, product release due date, and product release date of each item of design change number S0002.

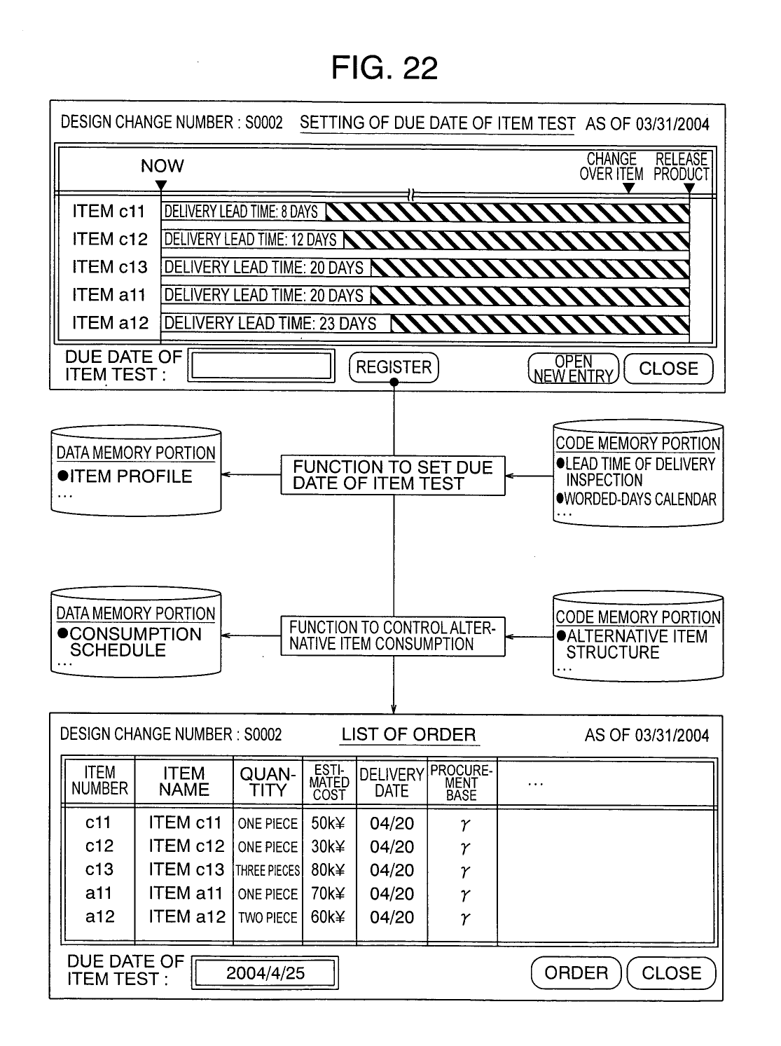

The processing status goes to FIG. 22. The person in charge, considering the delivery lead time, item changeover due date and product release due date of each item displayed on the screen, enters an item test due date. When the person clicks “REGISTER” button after the input of the item test due date, the function to register item test due date setting is actuated to refer to the delivery inspection lead time and worked-days calendar of the code memory portion, to calculate the delivery date back from the item test due date and to make it held in the item profile of the data memory portion. While the item test due date is fixed as above, the present invention, further considering the possibility that the items to be tested get behind the delivery date, performs consumption control of alternative items in addition to the shipping order of items to be tested. Specifically, the possible consumption of the alternative item c01 to the item c11 given as an example in this embodiment is also calculated, so that the possible consumptions of c11 and c01 can be associated with each other and incorporated in the consumption schedule of the data memory portion. A list of order sheet is displayed on the screen. This list also contains the delivery date that is calculated back from the item test due date while the delivery inspection lead time and worked-days calendar is being referred to. When the operator clicks the “ORDER” button, the item is automatically ordered with the delivery date fixed in conformity with the predetermined item test.

In addition, at this time (March 31), when the image of item specification list is displayed, and when an item is specified, the stock transition computing function is actuated to calculate the stock transition of the specified item on the basis of the stock capacity and alarm capacity of the code memory portion and the delivery schedule, consumption schedule, and inventory experience of the data memory portion and to make it be displayed on the screen. The stock status can be grasped from this image.

(5. 5) Item Test Configuration Planning Step

The process for planning item test configuration will be described next.

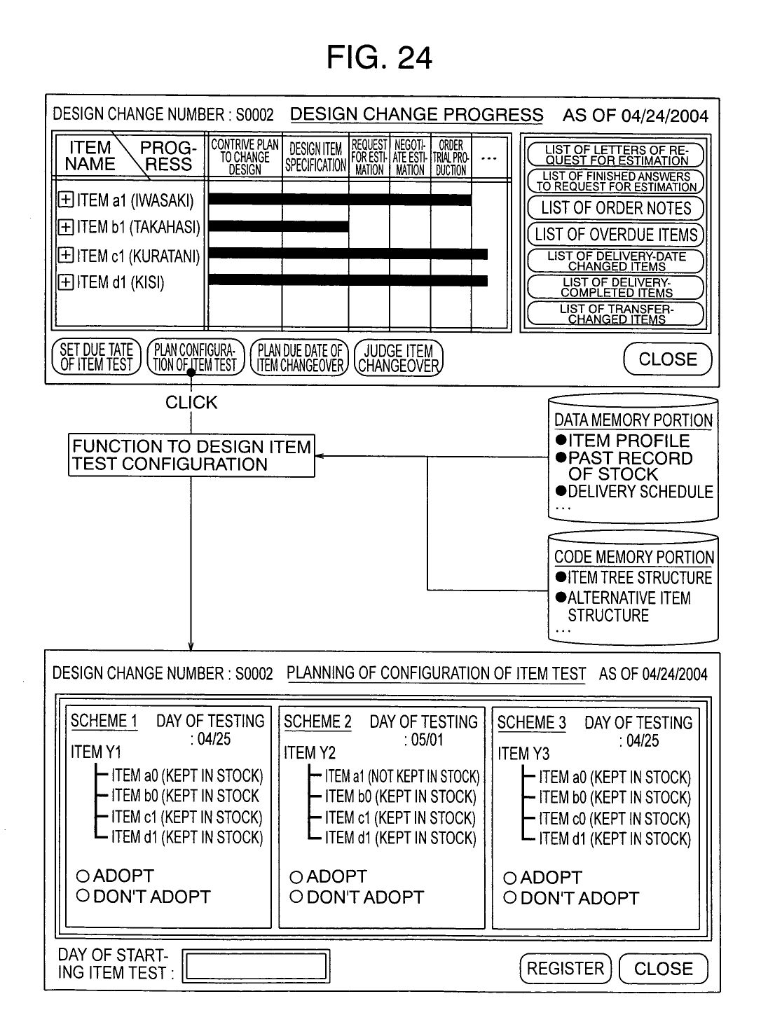

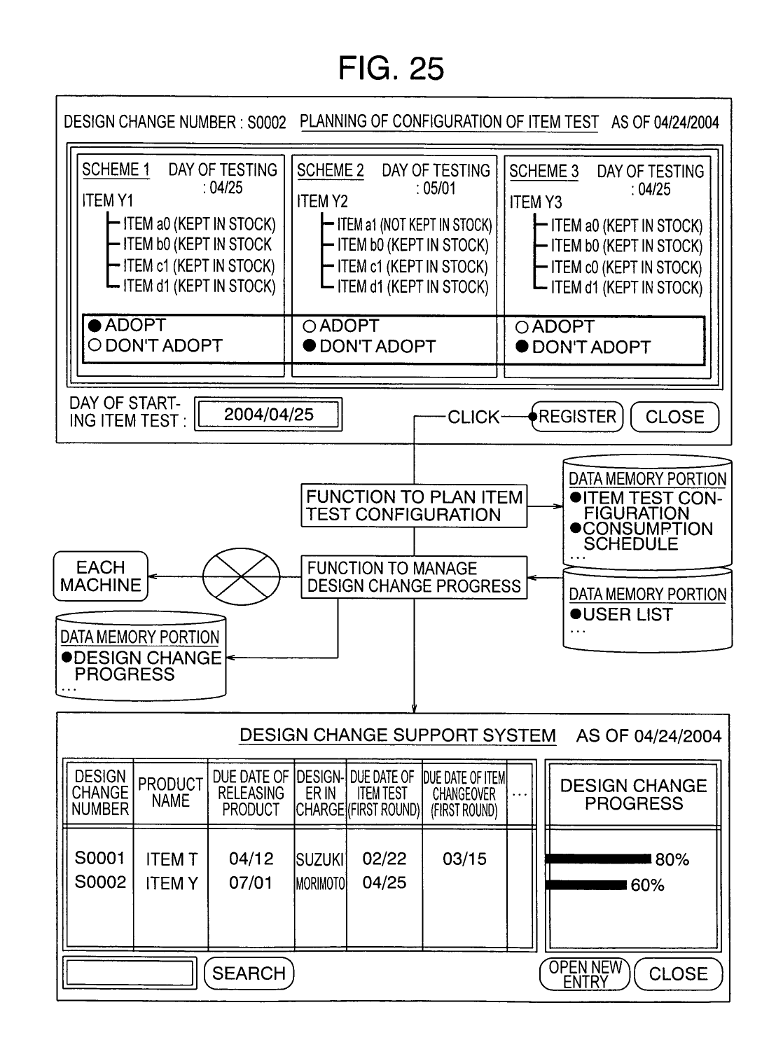

In the item test configuration-planning step 505, the system evaluates the effectiveness of the configuration of the item test fixed on the item test planning date (March 31) in view of the delivery status and stock status of the item, and contrives one or more schemes of the test configuration. Also, in this step, the schemes of the test configuration are set out to the user, and the registration of the item test configuration is accepted. In addition, in this step 505, after accepting the registration of the item test configuration, an item transfer instruction is issued to the low-order item stock base β so that the item can be placed under the control of the high-order item stock α from the low-order item stock base β. In this embodiment, this test start judgment date is fixed on Apr. 24, 2004. The processing content of this step 505 will be described with reference to FIGS. 24 and 25.

As illustrated in FIG. 24, the image of design change progress is first displayed, and the “PLAN ITEM TEST CONFIGURATION” button is clicked. Then, the item test configuration planning function is started to refer to the item profile, inventory experience, and delivery schedule of the data memory portion and the item tree structure and alternative item structure of the code memory portion, and to calculate and present one or more schemes of item configuration that can be tested on days near the item test due date fixed as item test planning date and possible dates for the schemes on the basis of those data and code.

The processing status goes to FIG. 25. The person in charge enters judgment result of acceptance or rejection to the presented schemes of item test configuration. In the column of the item test start date is automatically written a test start date on the basis of the inputted judgment result. When the “REGISTER” button is clicked after the input of acceptance or rejection, the function to plan item test configuration registers the accepted item test configuration in the data memory portion, and the function to manage design change progress transmits the content of the decision to the related base machine so that the information can be shared. Then, after it is reviewed and approved if necessary, the design change completion rate is computed, updated and stored in the data memory portion. In this example, since the item test configuration planning process has been completed, the percentage of completion of design change is 60%.

(5. 6) Item Test Making Step

In the step 506 for performing the item test, the item test is carried out according to the item test date and item test configuration selected on the test start judging date. In this embodiment, this test start date is fixed on Apr. 25, 2004.

(5. 7) Test Result Registering Step

The item test result registering process will be described next.

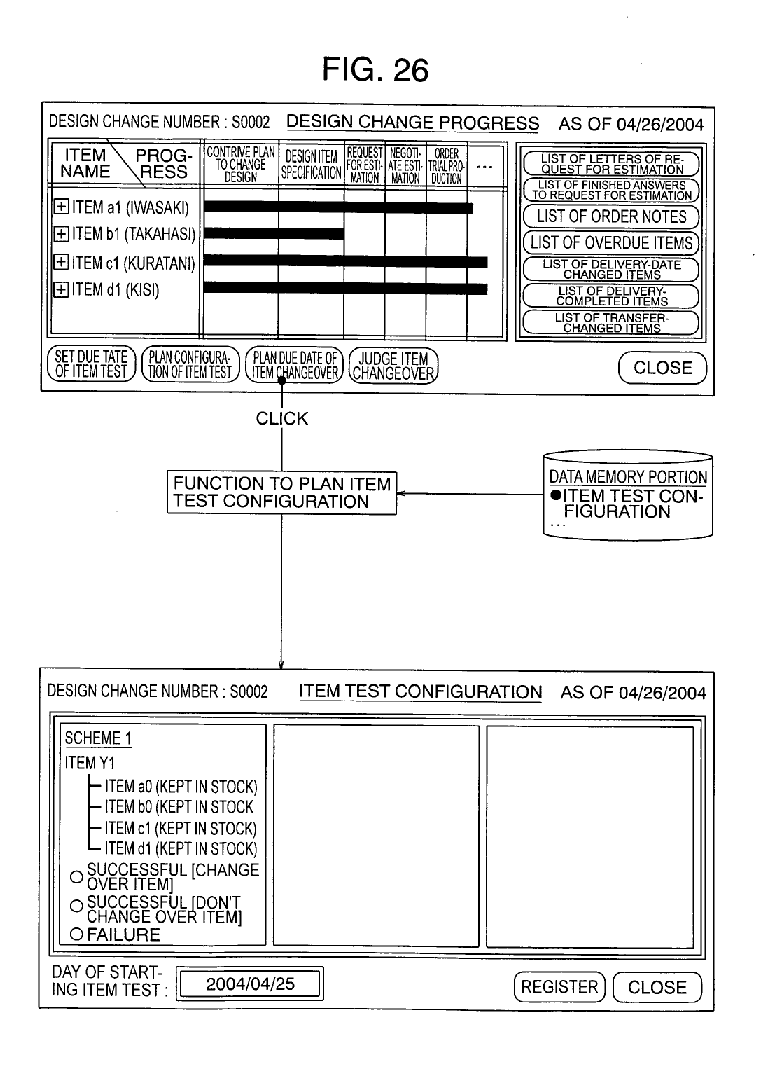

The test result-registering step 507 is the step for accepting and performing the registration of the test result. In addition, the step 507, when partial item changeover is made according to the successful test result, fixes the changeover due date and makes a process for ordering necessary low-order items after changeover. Also, the step 507 modifies the consumption schedule of current low-order items registered in the previous step 504. In this embodiment, this item changeover due date is fixed on Apr. 26, 2004. The processing content of this step 507 will be described with reference to FIGS. 26 through 28.

First as illustrated in FIG. 26, after the end of item test, the “PLAN DUE DATE OF ITEM CHANGEOVER” button is clicked in the image of design change progress. Then, the function to plan item test configuration is actuated to read out from the data memory portion the item test configuration registered on April 24 and to make it be displayed. Since the test date lapsed, buttons for entering the test result are displayed on the screen. Here, three different choices of “SUCCESSFUL (SWITCH ITEMS)”, “SUCCESSFUL (DON'T SWITCH ITEMS)”, and “FAILURE” are displayed as the option for entering the test result.

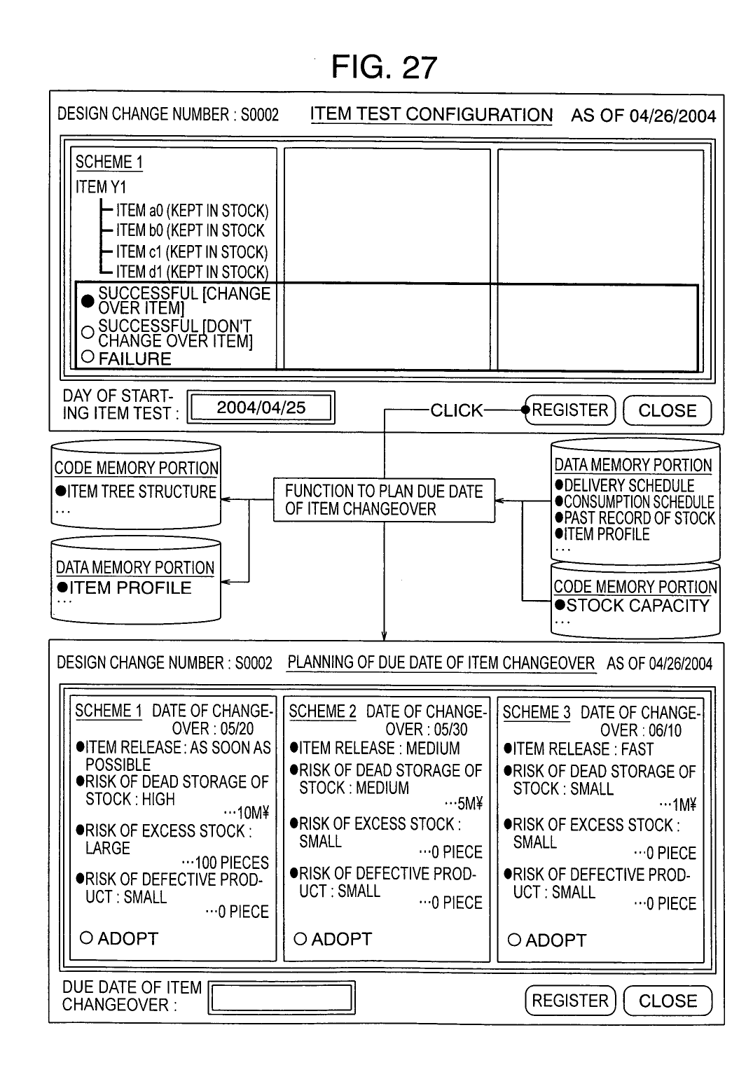

The processing status goes to FIG. 27. In this embodiment, “SUCCESSFUL (DON'T SWITCH ITEMS)” is selected, and the “REGISTER” button is clicked. Then, the function to plan item changeover due date is actuated to first store the information of this scheme 1 in the item tree structure of the code memory portion and in the item profile of the data memory portion. Also, it finds out one or more possible item changeover dates on the basis of the delivery schedule, consumption schedule, inventory experience and item profile of the data memory portion and the stock capacity of the code memory portion, and calculates and displays the judgment of whether the item release time is early or late, the risk of dead storage involving the item changeover, risk of excess inventory capacity and high-risk or low-risk of defective product.

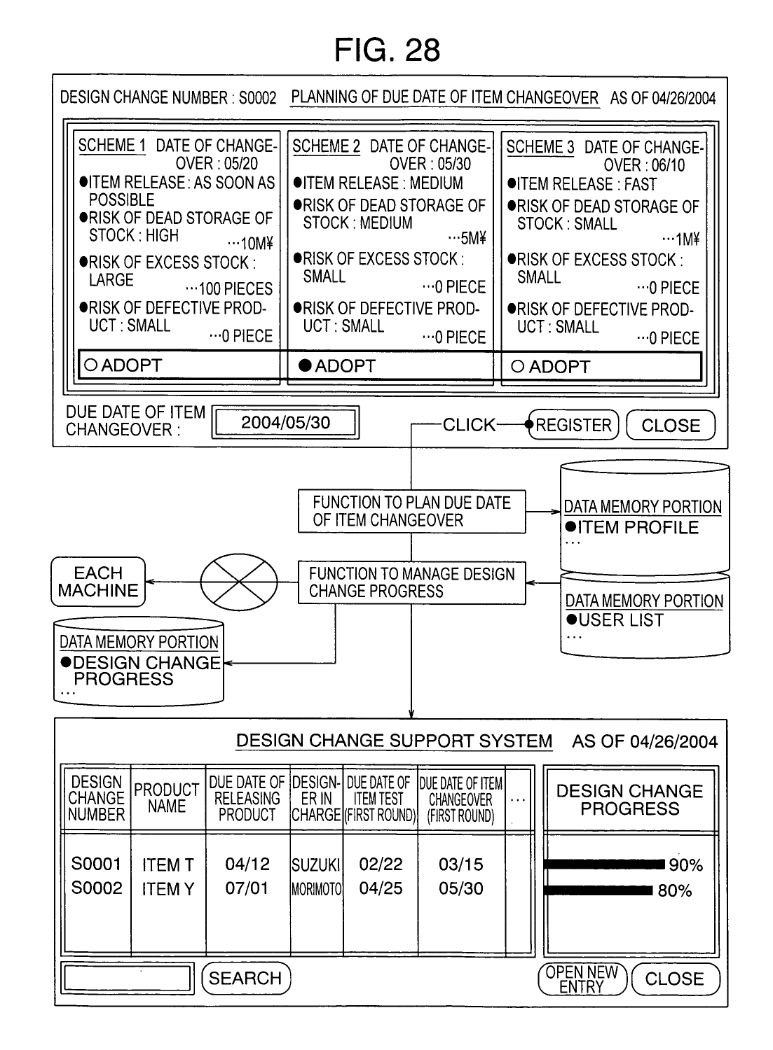

FIG. 28 shows the case where the scheme 2 is selected as an item changeover due date. When the “REGISTER” button is clicked after the selection of the second scheme, the function to plan item changeover due date is first actuated to hold the changeover due date in the item profile. Subsequently, the function to manage design change progress is actuated to refer to the user list of the data memory portion and to transmit information of the second scheme registered as an item changeover due date to the related base machine so that it can be shared. In addition, after it is reviewed and approved if necessary, the design change progress data is updated. FIG. 28 shows that the progress of design change of number S0002 has been completed up to the registration of item changeover due date, or has reached 80% of completion.

(5. 8) Item Changeover Judging Step

The process for deciding the item changeover planning date will be next described below.

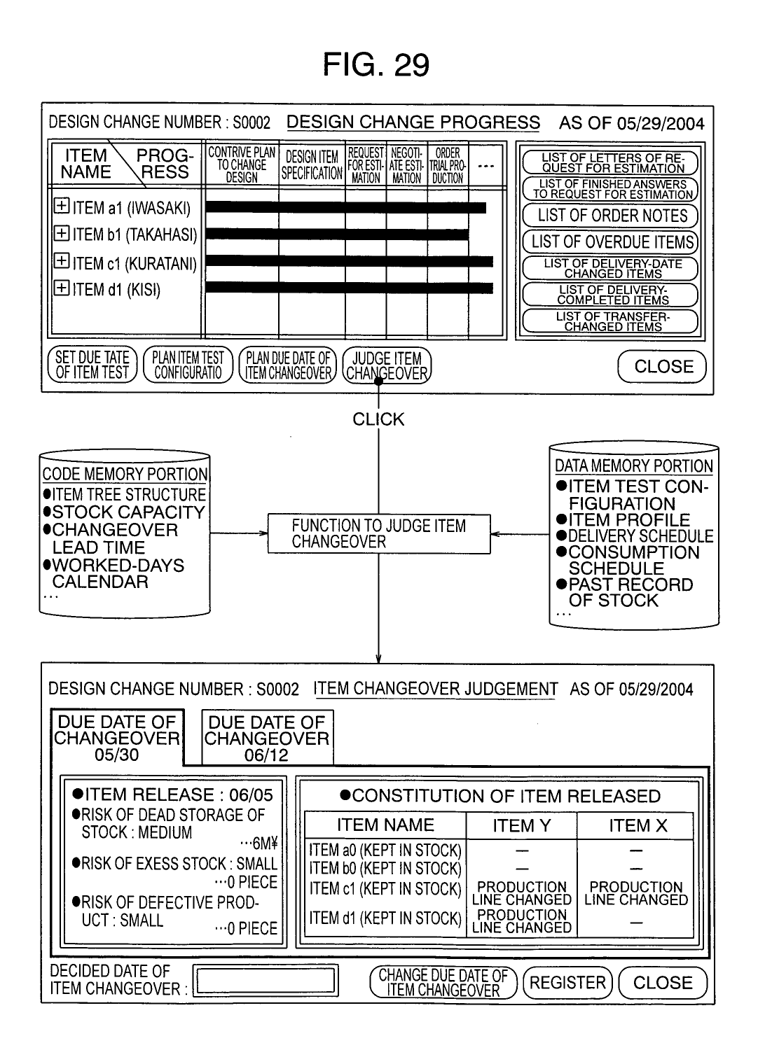

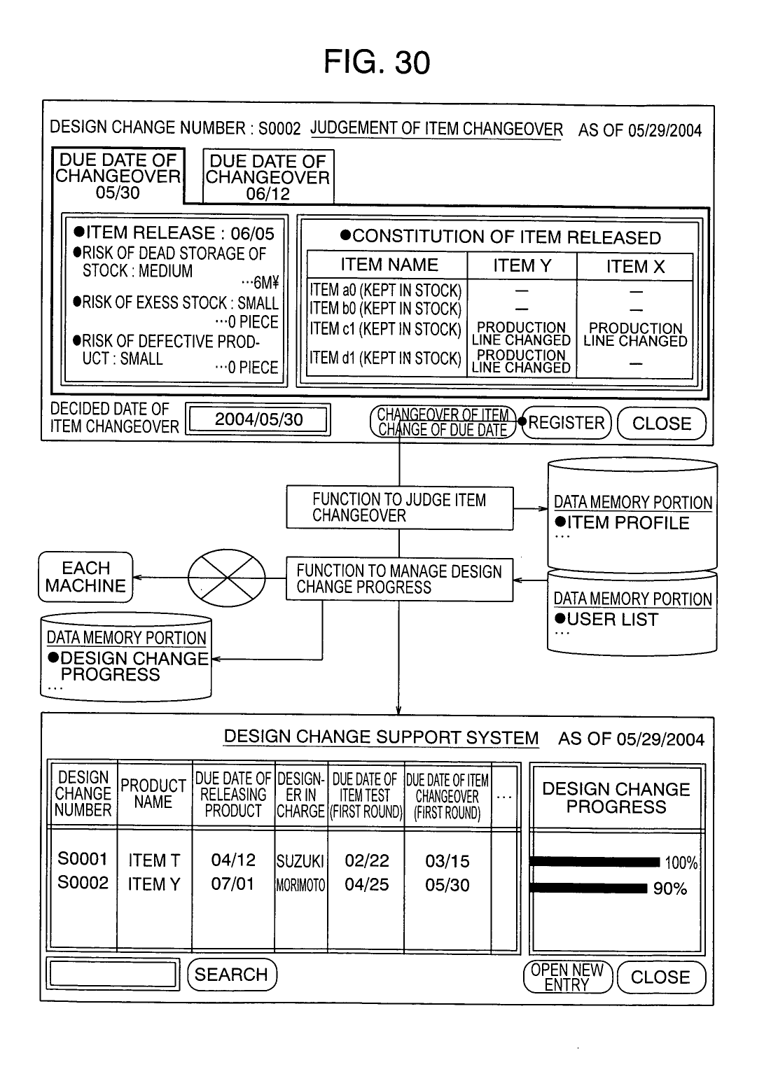

In the item changeover judging step 508, the system evaluates the effectiveness of the item changeover date and changeover range fixed on the item switching planning date on the basis of the information of item delivery status and stock status, and the person in charge registers the fixed item changeover date on the basis of the evaluation result. Also, in the item changeover judging step 508, the high-order item production base δ issues the item transfer instruction to the low-order item stock base β so that the selected item can be placed under the control of the low-order item stock base δ from the high-order item production base β. In this embodiment, this item changeover judging date is fixed on May 29, 2004. The processing content of this step 508 will be described with reference to FIGS. 29 and 30.

First in the image of design change progress shown in FIG. 29, when the “JUDGE ITEM CHANGEOVER” button is clicked, the item changeover judging function is started. The item changeover judging function refers to the delivery schedule, consumption schedule, inventory experience, item profile and item test configuration of the data memory portion and the item tree structure, stock capacity, changeover lead time and worked-days calendar of the code memory portion, calculates the item release date, the risk of dead storage in the stock, the risk of excessive amount of stock and the risk of defective product on the basis of those data and code, and writes them in the image of item changeover judgment. In the item release configuration area of this item changeover judgment image is also written the presence or absence of the production line change of low-order items that is calculated on the basis of those data and code.

The processing status goes to FIG. 30. After checking these judgment content, the operator enters the decided item changeover date (in this embodiment, May 30, 2004), and clicks the “REGISTER” button. Then, the item changeover judging function is actuated to hold the inputted fixed item changeover date in the item profile of the data memory portion. Subsequently, the function to manage design change progress is actuated to refer to the user list and to transmit the information of the decided item changeover date to the related base machines. Therefore, the related bases can share the information. The registration of the fixed item changeover date is reviewed and approved if necessary, and then the design change progress data is updated since this process has been completed. FIG. 30 shows that the design change progress data has been updated and has reached 90% of completion.

The design change process further progresses to the partial item-changeover step 509, the total item changeover step 510 and the item release-processing step 511, in turn.

(5. 9) Partial Item Changeover Step

In the partial item changeover step 509, some of items are changed over according to the item changeover date and changeover range selected on the item changeover judging date. In this embodiment, this item changeover judging date is fixed on May 30, 2004.

(5. 10) Total Item Changeover Completing Step

The total item changeover completing step 510 is the step for processing to complete the changeover of all items. In this embodiment, this final changeover start date is fixed on Jun. 28, 2004.

(5. 11) Item Release Processing Step

The item release-processing step 511 is the step for processing to release the item Y. In this embodiment, this item release date is fixed on Jul. 1, 2004.

Thus, according to this embodiment mentioned above, the various operations of design development processes can be made effective by the method for consolidating the operations of testing a plurality of products and of estimation request/order and for sharing information between the related bases, and the workload can be reduced by systemizing the method. In addition, the excess or deficiency of the stock of members can be suppressed from occurring by the method in which the product test time, test configuration and product changeover time are adjusted by using data of the member delivery status, stock status and consumption schedule that change in real time.

It should be further understood by those skilled in the art that although the foregoing description has been made on embodiments of the invention, the invention is not limited thereto and various changes and modifications may be made without departing from the spirit of the invention and the scope of the appended claims.

1. A design change support system for supporting the implementation of the plan for the test of products and changeover of members that is caused by the change of said members constituting each of said products,
said design change supporting system having an input unit, an output unit, a memory unit and a processing unit,
said memory unit having stored therein profile data containing information of said products and said members, alternative relevant data containing the relation between an old member of said members before design change and a new member of said members after design change, and data of the current status and schedule of inventory, consumption and delivery of each member,
said processing unit
reading out at least a delivery lead time, from a procurement base, of each member held in said profile data and supplying said delivery lead time to said output unit;
ordering ones of said members necessary for said product test on the basis of a product test due date inputted through said input unit and calculating a consumption schedule of alternative members with reference to said alternative relevant data;
contriving one or more schemes of test configuration containing the constitution of members of each product that can be tested on a day near the due date for said product test, and a test start day by using said delivery and stock status data of each member and said alternative relevant data stored in said memory unit, supplying said schemes to said output unit and accepting the result of selecting said test configuration from said input unit;
evaluating, in response to the result of product test supplied from said input unit, the effectiveness of said changeover of members of the constitution of a product judged to be capable of design change by using data of inventory and consumption of each member stored in said memory unit, contriving one or more schemes of member-changeover due date and supplying said schemes to said output unit; and
accepting the result of selecting a due date scheme for the changeover of members from said input unit, evaluating the effectiveness of the changeover of members on said selected member-changeover due date by using said data of delivery and stock status of members stored in said memory unit, and supplying said evaluation result to said output unit.

2. A system according to claim 1, wherein said processing unit further
calculates a consumption schedule of alternative relevant members contained in the configuration scheduled to be tested on said test due date by using said alternative relevant data and data of delivery, consumption and inventory of each member stored in said memory unit, and makes said consumption schedule be stored in said memory unit; and
modifies said calculated consumption schedule by using said selected scheme of member-changeover due date stored in said memory unit, and makes it be stored in said memory unit.

3. A system according to claim 1, wherein said processing unit
further generates a prototype of the profile data of a new product on the basis of the profile data of an old product, produces the profile data of said new product on the basis of information supplied from said input unit, and makes it be stored in said memory unit.

4. A system according to claim 1, wherein said processing unit
further controls said memory unit to store said one or more schemes of test configuration and said selected configuration scheme, and said one or more schemes of member-changeover due date and said selected due date scheme.

5. A design change support method for supporting the implementation of the plan for the test of products and changeover of members that is caused by the change of said members constituting each of said products, said method comprising the steps of:
storing profile data containing information of said products and members, alternative relevant data containing the relation between an old member of said members before design change and a new member of said members after design change, and data of the current status and schedule of stock, consumption and delivery of each member;
reading out, at least a delivery lead time from a procurement base, of each member held in said profile data;
when a product test due date is entered, ordering to send members necessary for said product test and calculating a consumption schedule of alternative members by referring to said alternative relevant data in response to said inputted product test due date; and
contriving one or more schemes of test configuration containing the constitution of members of each product that can be tested on a day near the due date for said product test, and a test start day by using said delivery and stock status data of each member and said alternative relevant data.

6. A method according to claim 5, further comprising the steps of:
calculating a consumption schedule of an alternative relevant member of the members contained in said configuration scheduled to test by using said alternative relevant data and data of delivery, consumption and inventory of each member; and
modifying said calculated consumption schedule by using said selected scheme of member changeover due date.

7. A method according to claim 5, further comprising the step of, when the result of said product test is entered, evaluating the effectiveness of the changeover of the members constituting a product that is judged to be capable of design change by using the data of the inventory and consumption of each member held in said memory unit, and contriving one or more schemes of member changeover due date.

8. A method according to claim 6, further comprising the step of, when the result of said selected scheme of member changeover due date is entered, evaluating the effectiveness of the member changeover on said selected scheme of member changeover due date by using the data of the delivery and stock status of each member stored in said memory unit, and supporting for the determination of the configuration and due date for the changeover of members.

9. A program for causing a computer to execute the procedure of a design change support method according to any one of claims 5 through 8.

10. A recording medium having a program stored for causing a computer to execute the procedure of a design change support method according to any one of claims 5 through 8.
